(19) United States
(12) Patent Application Publication
(10) Pub. No.: US 2008/0087833 A1
(43) Pub. Date: Apr. 17, 2008

(54) MODULAR MULTI-MODAL TOMOGRAPHIC DETECTOR AND SYSTEM

(76) Inventors: William K. McCroskey, Solon, OH (US); William Scott LeMaster, Solon, OH (US); Michael E. Milliff, Chapin, SC (US); T. William Milliff, Montville, OH (US); William D. Dickinson, Northfield, OH (US); Walter A. Summerhill, Orwell, OH (US); Antoine Ina, Richmond Heights, OH (US); Ethan T. Kay, Montville, OH (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/745,869

(22) Filed: May 8, 2007

Related U.S. Application Data
(63) Continuation-in-part of application No. 11/074,239, filed on Mar. 7, 2005.

(51) Int. Cl. G01T 1/20; G01T 1/24; G03B 42/02

(52) U.S. Cl. 250/370.08; 250/361 R; 378/167

(57) ABSTRACT

A multi-modality detection system and method for detecting medically-related conditions is disclosed. In some respects, the system and methods rely on at least two different modalities for imaging a region of interest including a patient organ such as the breast, brain, or other object within the region of interest. The two or more modalities are enabled with respective detectors as described herein and a respective output of each is collected and formed into a combined (fused) output representative of the plurality of different imaging modalities to enable imagine, diagnosis, study, or treatment of the medical condition.

### I. RELATED APPLICATIONS

The present application is a continuation in part (CIP) of and claims priority to U.S. patent application Ser. No. 11/074,239, entitled “Breast Diagnostic Apparatus for Fused SPECT, PET, X-ray CT, and Optical Surface Imaging of Breast Cancer,” filed on Mar. 7, 2005, which is hereby incorporated by reference.

### II. TECHNICAL FIELD

The present disclosure relates, in general, to gamma ray and x-ray detector systems and signal processing for nuclear medicine gamma cameras, single photon emission tomography (SPECT), positron emission tomography (PET), x-ray computed tomography (CT), digital radiology, x-ray mammography, and other limited field of view gamma ray and x-ray detection and signal processing instrumentation.

### III. BACKGROUND

This application relates to the field of gamma ray imaging, nuclear SPECT imaging, PET imaging, x-ray CT imaging, digital radiography (DR) imaging, x-ray mammography, optical imaging, optical fluorescence imaging, small field of view imaging detectors and probes, and used multimodality imaging.

In breast imaging and screening, x-ray mammography is being used as a screening tool for women over the age of 40 years. During the screening process, 40% of women have dense breast or suspicious breast indications for cancer. The radiologists reading these mammograms have difficulty reading the dense breast x-ray mammograms. A better method is needed for detecting cancer in dense breasts. Currently 8 out of 10 biopsies done on these patients indicate a false positive from x-ray mammography.

To improve the detection of breast cancer in women having dense breasts, a combination of molecular cellular functional images and x-ray density images of the breast is needed. Radioisotopes such as Tc-99m Sestamibi and positron isotopes such as FDG-F18 uptake in cancerous cells more rapidly than normal cells. Tc-99m Sestamibi molecules uptake in the mitochondria of the cell. Cancerous cells have more mitochondrial activity in comparison to normal surrounding cells. Similarly FDG F-18 uptake in cancerous cells is due to more glucose metabolism. The breast cancer cells uptake these isotopes more rapidly than the surrounding normal tissue. Thus, cancerous cells will emit more gamma rays as compared to normal cells.

In order to build a more sensitive and specific breast imaging device, the device must have higher spatial resolution and better contrast sensitivity than whole body imaging systems. Also the device must provide the location of the radioisotope distributions and anatomical x-ray density of breast tissues. In addition, the device must provide anatomical surface imaging of the breast superimposed with the radioisotope distributions and x-ray density of breast tissues and micro calcifications in three dimensions.

Today, projection x-ray mammography is used to detect breast density by compressing the breast tissue causing pain in some instances to the patient undergoing the mammographic exam. Once this exam has been completed and a dense breast indication has been found, there is not an easy alternative except to biopsy the breast tissues by surgery.

Scintigraphy has been used in conjunction with whole body gamma cameras with Tc-99m Sestamibi, but the sensitivity specificity drops below 40% when cancerous lesions are less than 2 cm in size. Ultrasound also may be used in the case of dense breasts but the procedure is very operator dependent. Therefore, there is a need for a more sensitive and specific breast imaging system which is comfortable for the patient and can provide true three dimensional information regarding potential breast cancer at the molecular level before anatomical changes occur. If there is a positive finding that breast cancer exists, then the system should provide three dimensional morphological information regarding the location of the cancer for surgical biopsy and rapid therapy.

### IV. SUMMARY

A multi-modality detection system and method for detecting medically-related conditions is disclosed. In some respects, the system and methods rely on at least two different modalities for imaging a region of interest including a patient organ such as the breast, brain, or other object within the region of interest. The two or more modalities may be enabled with respective detectors as described herein and a respective output of each may be collected and formed into a combined (fused) output representative of the plurality of different imaging modalities to enable imagine, diagnosis, study, or treatment of the medical condition.

The present disclosure comprehends simultaneous application of more than one type of medical imaging (or imaging modality) to an organ or portion of a subject's body. For example, various imaging modalities that can be employed by the present systems and methods include gamma detection, X-ray detection, SPECT, PET, and other modalities that are used in tomographic systems for the purpose of detecting, sensing, generating images, diagnosing, locating, and treating a physiological or medical condition. Some conditions comprehended hereby include dementia in its various forms, for example, breast diseases such as breast cancer, diseases in the human head and brain, including neuro-degenerative diseases, Alzheimer's disease, Pick's disease, Huntington's disease, and multiple infarct conditions.

The present system and methods provide for simultaneous or substantially simultaneous measurement and detection of a physical event to cause a sensor to respond thereto. By proper application of such a sensor it is possible to construct a detector apparatus for detecting the event or plurality of events an image of an underlying physiological object or feature of the object, condition, disease, contrast agent, or body part or organ may be obtained. Receiving additional information from more than one imaging detector representing more than one imaging modality can provide an improved and better resolved and more clinically meaningful image of a subject or condition under investigation.

Some embodiments of the present disclosure are directed to a medical imaging apparatus, comprising a first detector contributing a first imaging modality for detecting a medical condition in a region of interest; a second detector contributing a second imaging modality for detecting said medical condition in said region of interest, said second imaging modality being different than said first imaging modality; and a structural frame supporting both of said first and second detectors, said frame maintaining a substantially fixed relative positioning between said detectors with respect to one another while allowing relative motion between said detectors and said region of interest.

Other embodiments are directed to a method for generating a multi-modal image for detecting a medical condition, comprising imaging a region of interest using a first imaging modality for detecting said condition; imaging said region of interest using a second imaging modality for detecting said condition; mechanically fixing respective detectors for said first and second imaging modalities to a structural support frame so as to substantially fix said respective detectors with respect to one another while allowing relative motion between said detectors; and combining respective outputs of said first and second imaging modalities so as to form a multi-modal combined output thereof indicative of said condition.

### V. BRIEF DESCRIPTION OF THE DRAWINGS

The present systems and methods can be better illustrated and understood in view of the accompanying drawings, in which:

FIG. 1 illustrates a top frontal view of an apparatus utilized by a breast scan system as described herein;

FIG. 2 illustrates a perspective view of an apparatus utilized by a breast scan system showing a patient on a patient table as described herein;

FIG. 3 illustrates a system block diagram showing an architecture as described herein;

FIG. 4 illustrates a perspective view of an apparatus showing a patient tilted to one side on a patient table as described herein;

FIG. 5 illustrates a perspective view of a patient on a patient table, and illustrates an upper outer quadrant gamma curved detector associated with a breast scan system as described herein;

FIG. 6 illustrates an exploded view of an upper outer quadrant gamma curved detector shown in FIG. 5;

FIG. 7 illustrates a top plan view of an upper outer quadrant gamma curved detector shown in FIGS. 5 and 6;

FIG. 8 illustrates a perspective view of an upper outer quadrant gamma curved detector, a central breast curved gamma detector, and a X-ray source and detector in an imaging system;

FIG. 9 illustrates a front elevational view showing a position of the imaging components of FIG. 8 with respect to a patient;

FIG. 10 illustrates a left end view showing a position of the imaging components of FIGS. 8 and 9 with respect to a patient;

FIG. 11 illustrates a front elevational exploded view of an upper outer quadrant gamma curved detector showing its position with respect to a patient;

FIG. 12 illustrates a left end exploded view of an upper outer quadrant gamma curved detector showing its position with respect to a patient at the beginning of a tomographic scan;

FIG. 13 illustrates a left end exploded view of an upper outer quadrant gamma curved detector and illustrates its position with respect to a patient partially through a tomographic scan;

FIG. 14 illustrates a left end exploded view of an upper outer quadrant gamma curved detector and illustrates its position with respect to a patient at the end of a tomographic scan;

FIG. 15 illustrates a perspective view of a central breast curved gamma detector, a central breast curved coincidence gamma detector, and a X-ray source and detector as described herein;

FIG. 16 illustrates a left end view and a side view of an upper outer quadrant gamma curved detector and a central breast curved coincidence gamma detector of a breast scan system as described herein;

FIG. 17 illustrates micro PET imaging lines of response produced by a PET imaging system as described herein;

FIG. 18 illustrates a perspective view of a single photon and coincidence gamma detector utilized by a breast scan system as described herein;

FIG. 19 illustrates an end view of the single photon and coincidence gamma detector shown in FIG. 18;

FIG. 20 illustrates a perspective view of a detector module utilized by the single photon and coincidence gamma detector shown in FIGS. 18 and 19;

FIG. 21 illustrates a front elevational view of a detector module shown in FIG. 20 and a perspective view of the pixelated gamma detector elements contained therein;

FIG. 22 illustrates a front plan view of a patient showing a central breast scan and illustrating a representative position of the single photon and coincidence gamma detector as described herein;

FIG. 23 illustrates an end view of a patient on a patient table showing an upper outer quadrant breast scan and a representative position of a single photon and coincidence gamma detector as described herein;

FIG. 24 illustrates a front plan view of a patient showing a X-ray scan of a breast and representative positions of the X-ray source and detector during a scan;

FIG. 25 illustrates an end view showing breast scan data acquisition orbits and reconstruction of radioisotope distributions in a breast utilizing the breast scan system as described herein;

FIG. 26 illustrates an end view showing breast scan data acquisition orbits and reconstruction of X-ray transmissions in a breast utilizing a breast scan system as described herein;

FIG. 27 illustrates a schematic diagram showing fusing of multimodality images by utilizing a breast scan system as described herein;

FIG. 28 illustrates a front elevational view of a patient on a patient table and illustrates stereo-tactic biopsy, minimally invasive surgery, and image-guided therapy using multimodality images produced by a breast scan system as described herein;

FIG. 29 illustrates a perspective view of a multi-modal tomographic modular imaging detector utilized in some embodiments hereof;

FIG. 30 illustrates an exploded component view of a multi-modal tomographic modulator imaging detector;

FIG. 31 illustrates a view of an exemplary pixilated 2D scintillation crystal array;

FIG. 32 illustrates a view of a 2D micro channel plate with a 2D matrix of anodes;

FIG. 33 illustrates a block diagram showing an exemplary independent channel processor cascaded with a multi-modality tomographic modular imaging detector;

FIG. 34 illustrates a functional block diagram of an exemplary independent channel event processor for the multi-modality tomographic modular imaging detector;

FIG. 35 illustrates a functional block diagram of an exemplary matrix event processor for the multi-modality tomographic modular imaging detector;

FIG. 36 illustrates an exemplary collimation and radiation shielding for the multi-modality tomographic modular imaging detector;

FIG. 37 illustrates an exemplary embodiment of a curved detector assembly using the multi-modality tomographic modular detector modules; and

FIG. 38 illustrates an exemplary coincidence imaging with two curved detector assemblies of a multi-modality tomographic modular detector system.

### VI. DETAILED DESCRIPTION

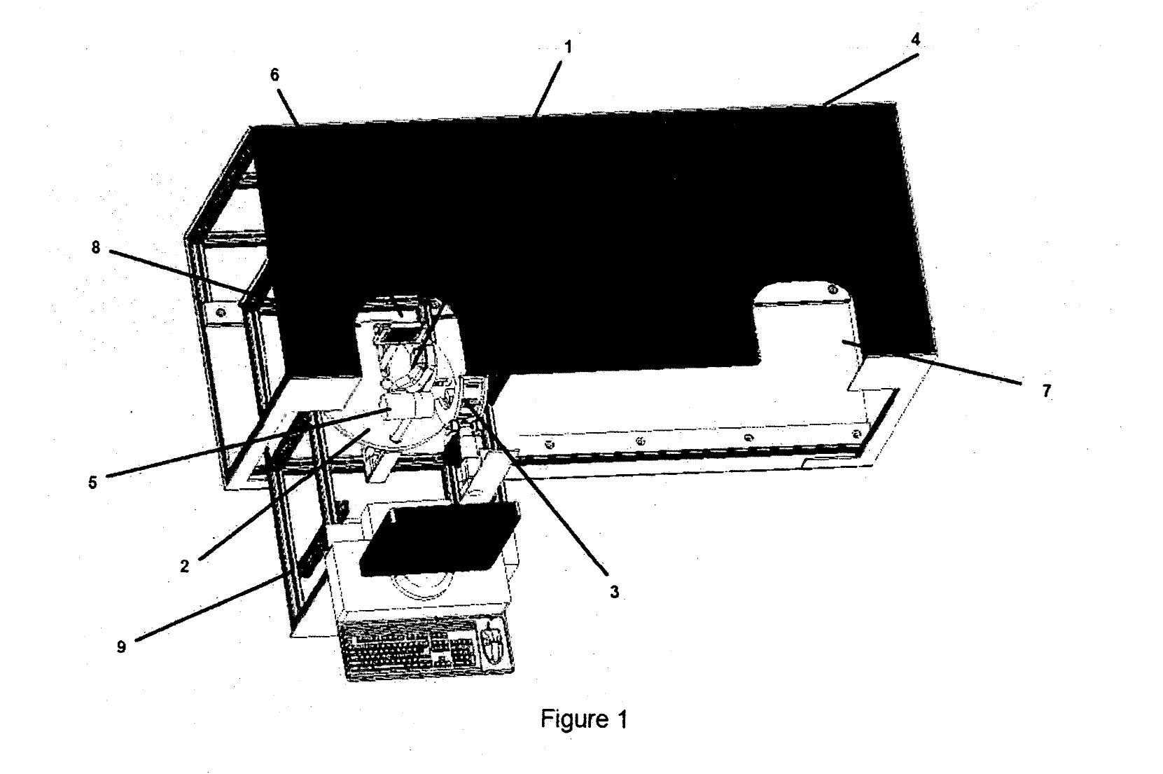

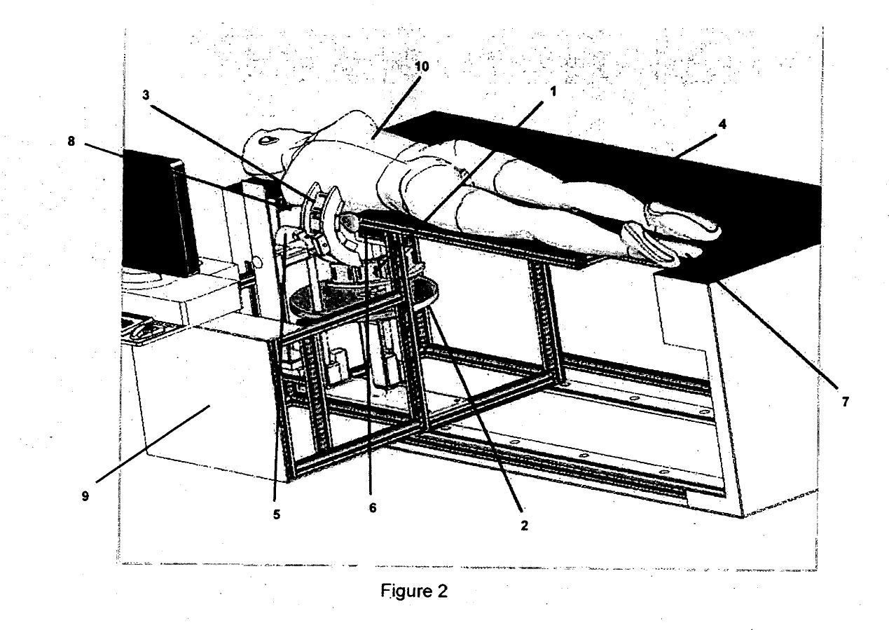

Referring now to the Figures where the illustrations are for the purpose of describing embodiments of the present invention and are not intended to it the invention disclosed herein, FIG. 1 illustrates a top frontal view of an apparatus that may be utilized by a breast scan system. As shown in FIG. 2, the patient 10 lies prone and slightly tilted to one side to allow full extension of the breast through a left breast hole 8 or right breast hole 7. The breast is scanned with an anatomic specific imaging central breast curved gamma detector 1 for single photon emission computed tomography (SPECT). Radioisotopes are injected into the patient 10 and emitted radiation is detected by the central breast curved gamma detector 1. The breast scan system also has an x-ray source 5 and an x-ray detector 6. The x-ray source 5 transmits x-rays through the breast of the patient 10 which are detected by the x-ray detector 6. The x-ray source 5 and x-ray detector 6 are rotated around the patient's breast on a rotate table 2. Also the central breast curved gamma detector 1 is rotated around the patient's breast on rotate table 2.

The upper outer quadrant gamma curved detector 3 can be positioned to image the upper outer quadrant of the breast to the axilla. The upper outer quadrant gamma curved detector 3 collects radioisotope information from the patient's breast area where the central breast curved gamma detector 1 cannot be positioned. The sliding detector carriage 9 allows the imaging components to be translated horizontally from the left breast hole 8 or to the right breast hole 7, and vice versa, to image the respective breast.

in FIG. 2, the patient 10 is shown lying prone and slightly tilted to one side on breast imaging patient table 4 and over left breast hole 8. The patient's breast is extended by gravity for imaging. The patient is injected with a radioisotope which accumulates in cancerous tissues of the breast more rapidly than normal tissues. The central breast curved gamma detector 1 detects gamma rays emitted from the radioisotope distributions. The central breast curved gamma detector 1 is designed to anatomically fit close to the shape of the central breast to collect gamma rays being emitted. The central breast curved gamma detector 1 is rotated around the patient's central breast by rotate table 2. The upper outer quadrant gamma curved detector 3 is positioned around the patient's thorax to collect gamma rays from the upper outer quadrant of the breast to the axilla. The breast anatomy is a complex imaging area and the system is designed to image the entire breast including the lymph nodes. The upper outer quadrant gamma curved detector 3 can be positioned three dimensionally around the patient's thorax with vertical, horizontal, traverse, and oscillations to collect data while being very close to the patient 10.

As shown, x-ray source 5 and x-ray detector 6 are mounted to the rotate table 2. This allows for x-ray micro computed tomography of the breast. The x-ray source 5, x-ray detector 6, and central breast curved gamma detector 1 are all positioned around the patient's breast on the rotate table 2 to acquire high resolution single photon emission computed tomographic (SPECT) images and x-ray high resolution computed tomography (CT) images of the breast. In addition, the sliding detector carriage 9 allows imaging of the left breast through the left breast hole 8 and then translates to right breast hole 7 for repositioning of the patient for right breast imaging.

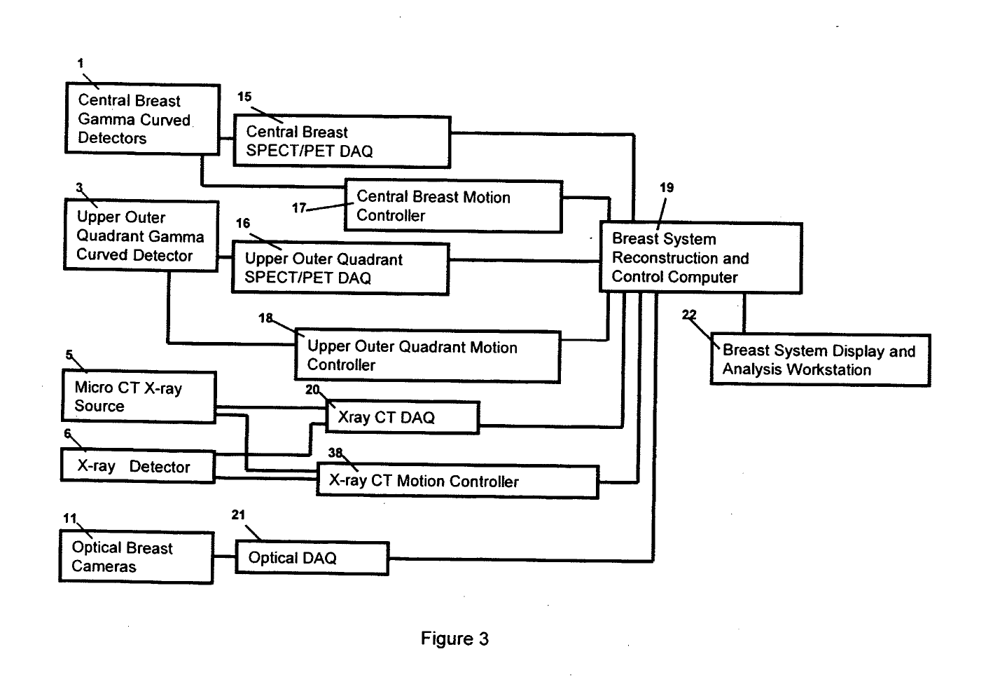

Referring now to FIG. 3, the overall architecture and system structure is shown. Gamma rays are detected by either the central breast gamma curved detector(s) 1 and/or the upper outer quadrant gamma curved detector 3. These detectors can collect gamma rays emitted from single photon emitting isotopes, such as Tc-99m, or positron emitting isotopes, such as F-18. When using the positron emitting isotopes, coincidence detection is used to collect and determine the angle of the pair of 180 degree opposed gamma rays emitted from a positron annihilation. The central breast SPECT/PET DAQ block 15 controls and acquires both single photon gamma rays and coincidence gamma rays from the central breast gamma curved detectors 1 to form isotope projection images. The central breast notion controller 17 controls the geometric positioning of the central breast gamma curved detectors 1 including, rotation, vertical, radial, oscillate, and tilt positioning. The upper outer quadrant SPECT/PET DAQ block 16 controls and acquires both single photon gamma rays and coincidence gamma rays from upper outer quadrant curved gamma detector 3 to form isotope projection images. The upper outer quadrant motion controller 18 controls the geometric positioning of the upper outer quadrant gamma curved detector 3 including rotation, vertical, radial, oscillate, and tilt positioning.

As shown, x-ray CT DAQ 20 interfaces with the micro CT x-ray source 5 and x-ray detector 6 to acquire projection x-ray images through the breast anatomy. The micro CT x-ray source 5 and x-ray detector 6 are positioned by the x-ray CT motion controller 38 for x-ray micro CT of breast densities. The x-ray CT DAQ block 20 controls and acquires data from the micro CT x-ray source 5 and the x-ray detector 6. The x-ray CT DAQ 20 controls the x-ray detector 6 to generate projection views through the breast anatomy and form two dimension frames of attenuated x-rays. For optical images of the breast, optical breast cameras 11 are attached to respective micro CT x-ray source 5, x-ray detector 6, central breast gamma curved detectors 1, and upper outer quadrant gamma curved detector 3. The optical DAQ 21 controls the optical breast cameras 11 to generate optical views of the breast for spectral image of the breast at various wavelengths. The breast system reconstruction and control computer 19 controls and collects data from respective data acquisition (DAQ) and motion controllers. Specifically, the projection gamma images, coincidence gamma images or positron emission tomography (PET) images, x-ray projection images, and optical images are processed by the breast reconstruction and control computer 19 to form micro SPECT volumes, micro PET volumes, micro CT volumes of the breast anatomical density and radioactive isotope uptake in breast tissues. Also the breast reconstruction and control computer 19 geometrically overlays the optical views of the breast in co-registration with micro SPECT, micro PET, and micro CT three dimensional information. The three dimensional breast data from the respective modalities of micro SPECT, micro PET, micro CT, and optical surface image spectrums are combined together or fused on the breast display and analysis workstation 22.

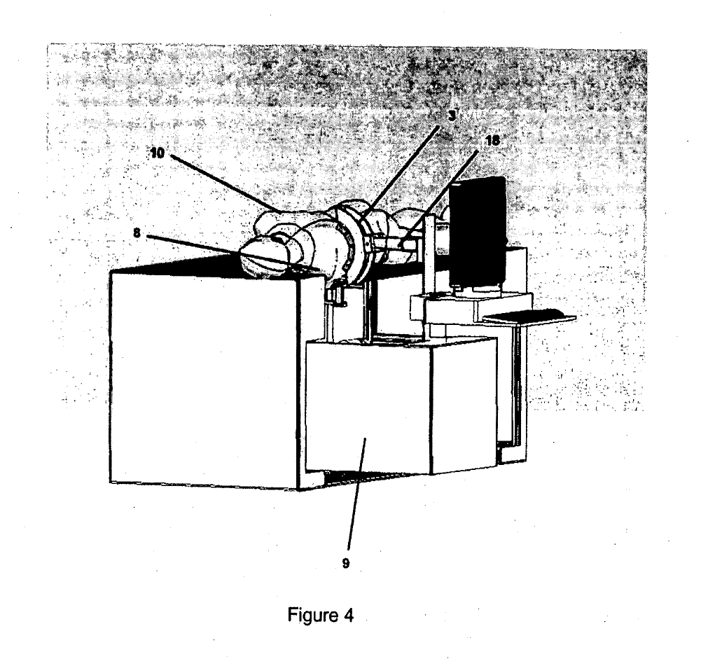

Referring now to FIG. 4, the patient 10 may lie on the patient table slightly tilted to one side to allow full breast extension by gravity into the left breast hole 8. The patient may be disposed in other configurations and positions with respect to the table, platform, or support structure or member. For example, the patient may be upright, in a standing or sitting position, while the patient's breast is suitably disposed within an imaging region of interest that allows imaging of the breast. The patient and the imaging system and detectors are thus oriented in a convenient and physically compatible way to obtain the multi-modal images as described herein, and not necessarily constraining the patient or the imaging apparatus to any particular absolute or relative orientation.

The sliding detector carriage 9 can be positioned interactively by an operator for alignment on the center of the left breast. The scans can then be done on the left breast. Also shown is the upper outer quadrant gamma curved detector 3 which can be positioned to image the upper outer quadrant of the breast. The upper outer quadrant gamma curved detector 3 can be positioned by the upper outer quadrant motion controller 18 in an elliptical and oscillatory motion to obtain enough views to tomographically reconstruct the upper outer quadrant region of the breast.

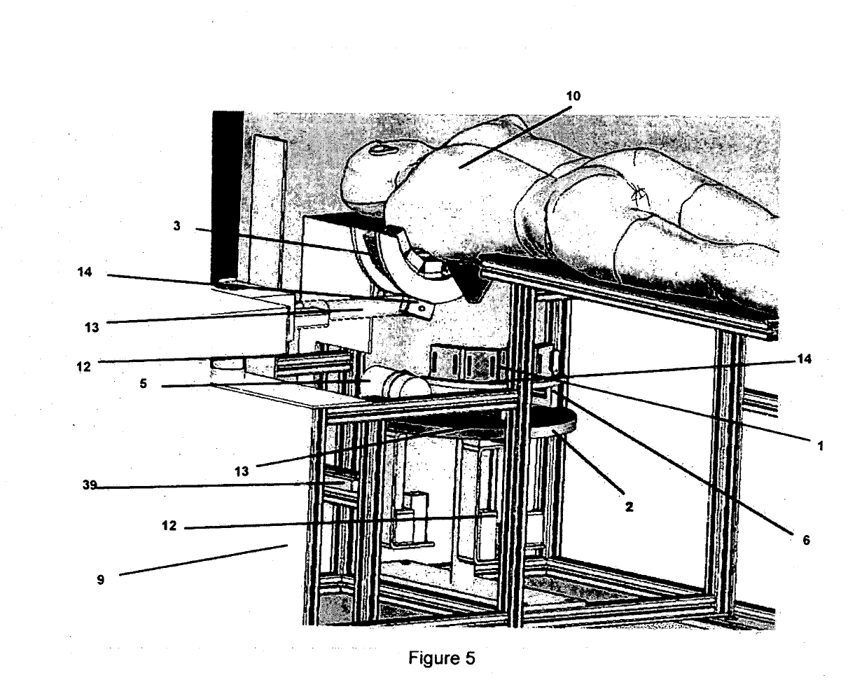

In FIG. 5, the patient 10 is shown lying prone and slightly tilted to one side with her left breast extended into the left breast hole. The central breast curved gamma detector 1 is shown mounted to an oscillate positioner 14, a vertical positioner 12, radial positioner 13, rotate table 2, and to the sliding detector carriage 9. The x-ray source 5 and x-ray detector 6 are also maneuvered about the patient's breast with their respective vertical positioners on rotate table 2. The upper outer quadrant gamma curved detector 3 is positioned around the patient's breast and thorax. The upper outer quadrant gamma curved detector 3 is maneuvered with its respective oscillate positioner 14, radial positioner 13, vertical positioner 12, traverse positioner 39, and sliding detector carriage 9.

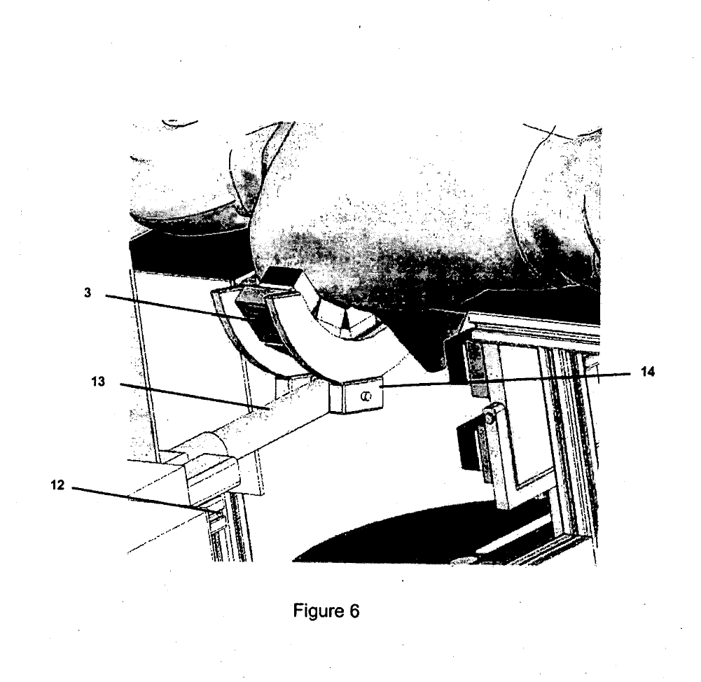

Referring now to FIG. 6, the upper outer quadrant gamma curved detector 3 is shown close to the patient's chest and upper outer quadrant of the patient's breast. The upper outer quadrant gamma curved detector 3 is positioned close to the patient's breast anatomy via oscillate positioner 14, radial positioner 13, vertical positioner 12, and transverse positioner 39 mounted on sliding detector carriage 9.

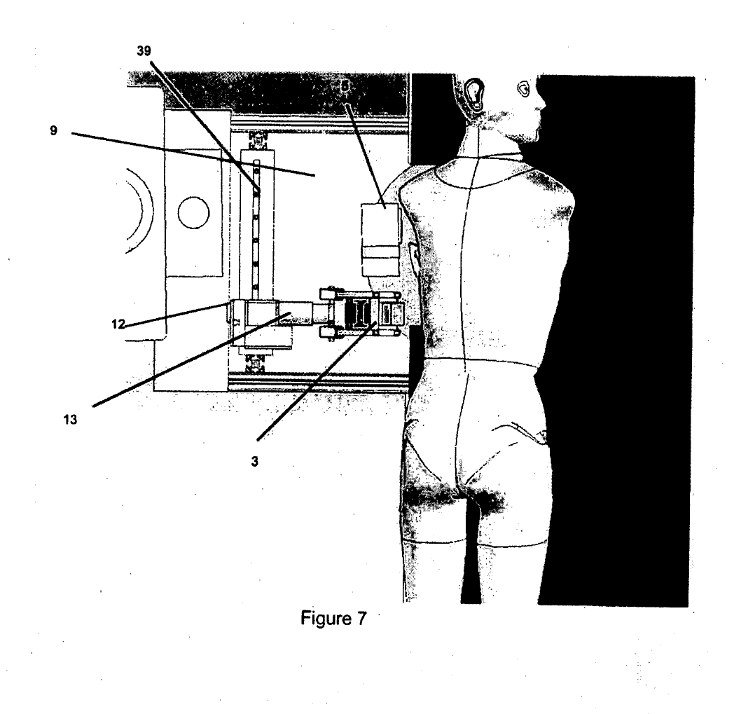

In FIG. 7, the upper outer quadrant gamma curved detector 3 is shown being positioned with coordinated motion via oscillate positioner 14, radial positioner 13, vertical positioner 12, and transverse positioner 39 mounted on sliding detector carriage 9.

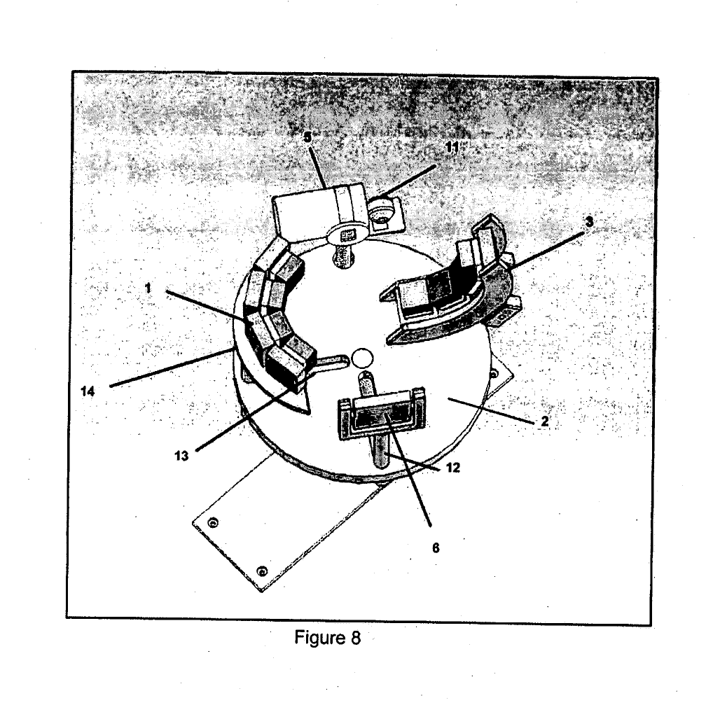

As shown in FIG. 8, the apparatus utilized to obtain multiple angular radioisotopes views, x-ray views, and optical spectrum views of the breast is illustrated. For the central breast scan, the central breast curved gamma detector 1, x-ray source 5 and x-ray detector 6 are rotated around the breast on rotate table 2. The central breast curved gamma detector 1 x-ray source 5 and x-ray detector 6 have a respective oscillate positioner 14, vertical positioner 12, and radial positioner 13 to be moved around the central breast in a coordinated motion to collect anatomic specific views. The position orbits and respective oscillations of respective components allow the central breast curved gamma detector 1 to be positioned close to the breast without touching the breast to improve spatial resolution of and sensitivity to radioisotope distributions within the breast. Also geometric and temporal x-ray views of the breast can be done with x-ray source 5 and x-ray detector 6 being positioned via their respective vertical positioners 12, radial positioners 13, and rotate table 2. The position of the upper outer quadrant gamma curved detector 3 can be synchronized with central breast imaging components.

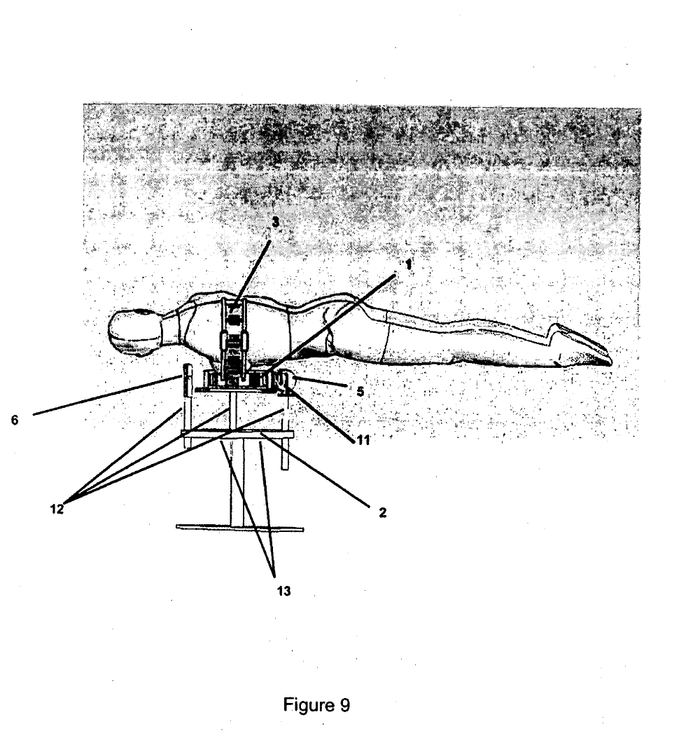

Referring now to FIG. 9, the system concept is shown from a side view with the patient 10 lying prone and slightly tilted to one side with full breast extension by gravity. The x-ray source 5 and x-ray detector 6 are shown with their respective vertical positioners 12 and rotate table 2.

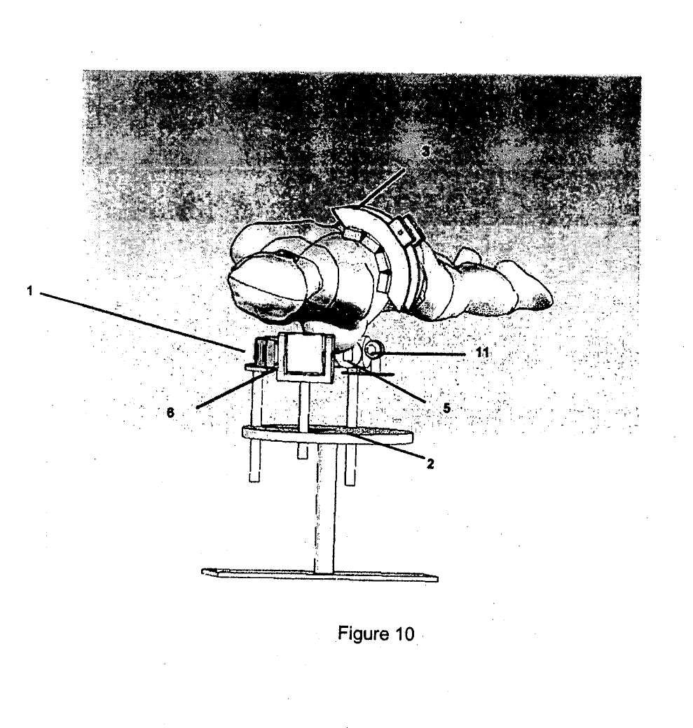

In FIG. 10, the central breast curved gamma detector 1 is shown collecting projection view data of radioisotope distributions while being positioned close to the breast anatomy. Also the x-ray source 5 and x-ray detector 6 are also positioned on common rotate table 2. An optical breast camera 11 is shown to take temporally synchronized views of the breast's optical reflections, transmissions, and fluorescence at various spectrums or wavelengths. One use of the optical views is for breast surface registration with respective x-ray transmission and radioisotope views.

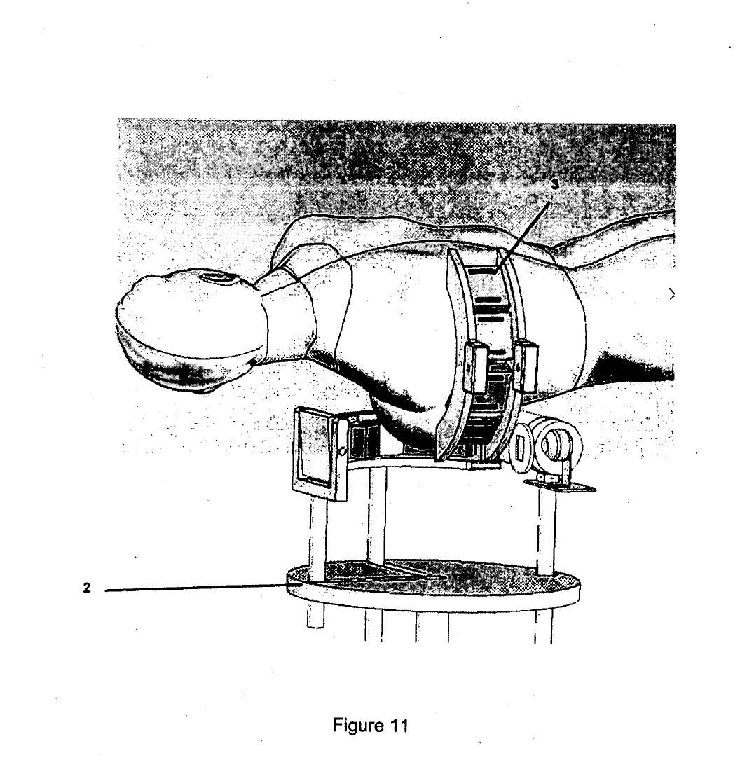

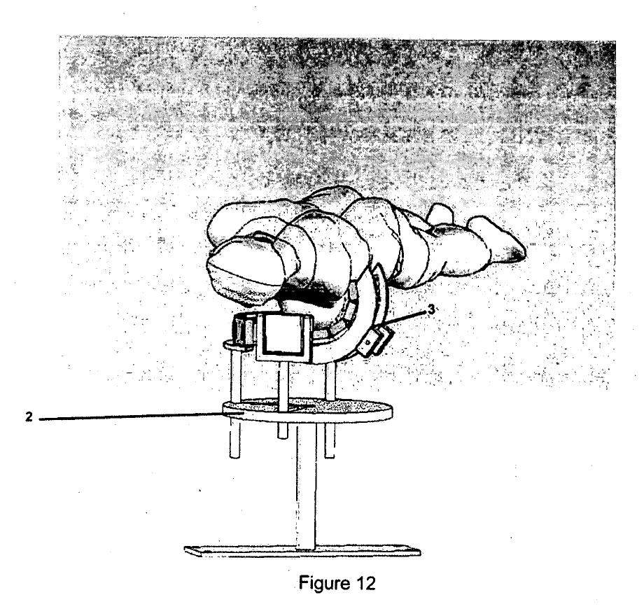

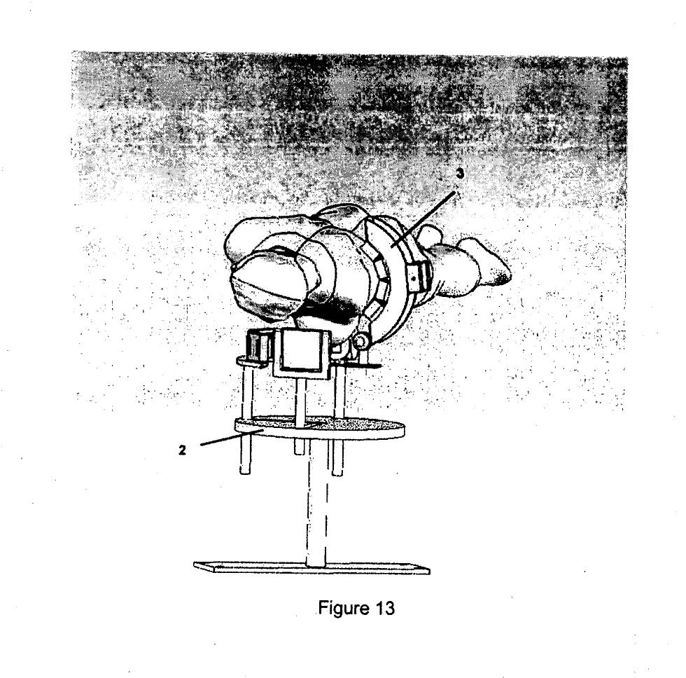

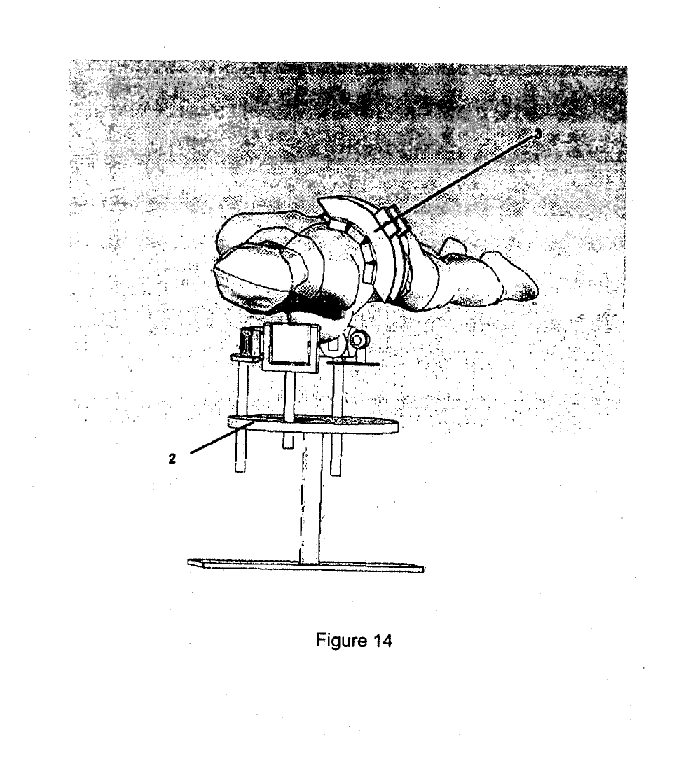

Referring now to FIGS. 11, 12, 13, 14, various positions of the upper outer quadrant gamma curved detector 3 are shown collecting gamma rays from radioisotope distributions within the breast and lymph nodes located close to the breast. The upper outer quadrant area of the breast is the location where 50% of cancers occur. FIG. 14 shows views from the back and left side of patient; FIG. 11 from the left side of patient and breast; FIG. 12 from the left front side of chest wall and breast; and FIG. 13 from the left back side of chest wall and breast.

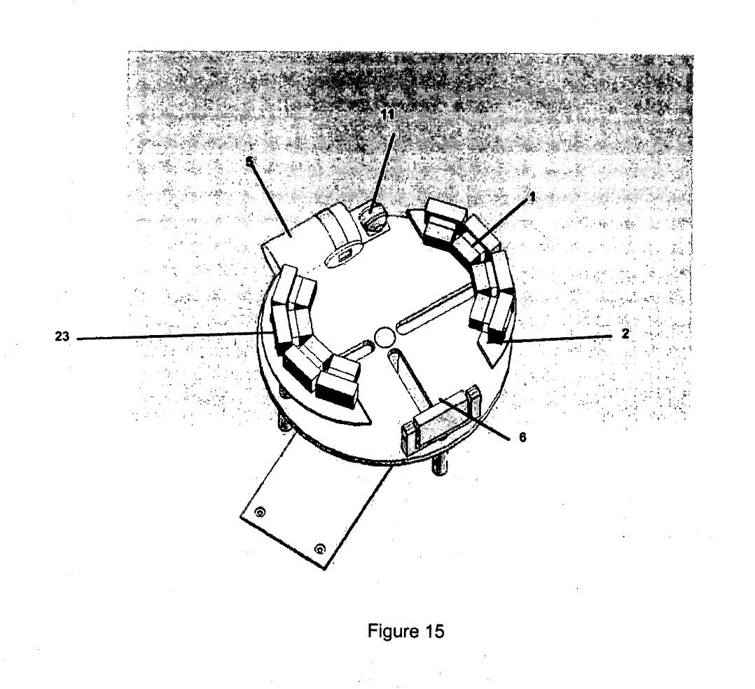

In FIG. 15, the central breast curved coincidence gamma detector 23 is shown to allow coincidence detection of positron emitting isotopes, like F-18. The central breast curved gamma detector 1 and central breast curved coincidence gamma detector 23 are operated with temporal coincidence window between each event collected on the respective detector to form a line of response (LOR) between detector elements. The central breast curved coincidence gamma detector 23 is also rotated on rotate table 2 and can be positioned with its respective positioners. Also, the central breast curved coincidence gamma detector 23 can be used for single photon gamma detection and work in concert with central breast curved gamma detector 1 to form SPECT image projections improving sensitivity and specificity of the imaging system.

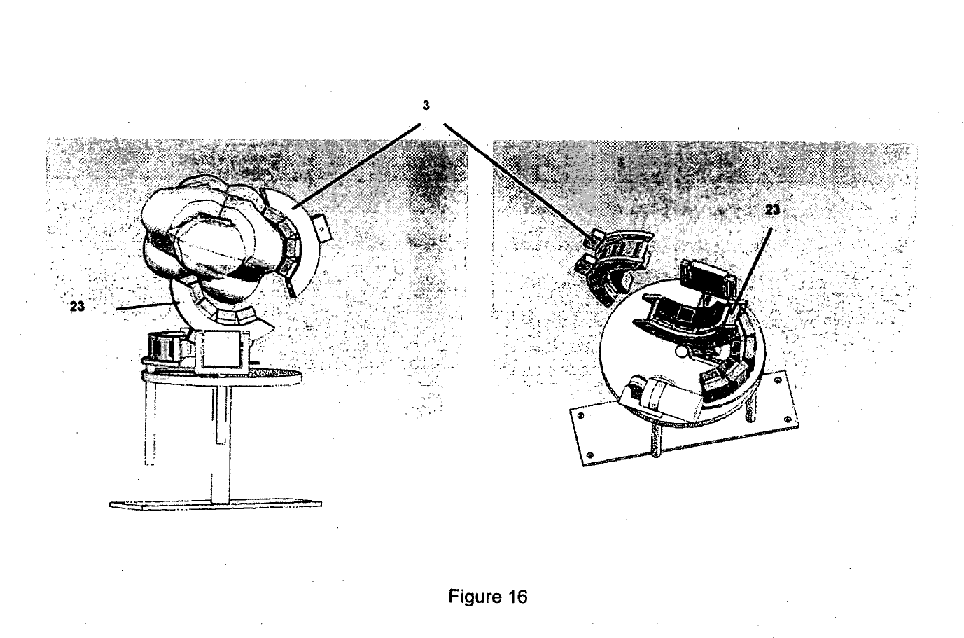

Referring now to FIG. 16, an exemplary central breast curved coincidence gamma detector 23 may be used to operate in coincidence with the upper outer quadrant gamma curved detector 3. This allows for positron imaging of the upper outer quadrant for detection of cancer and lymph node uptake of radioisotope.

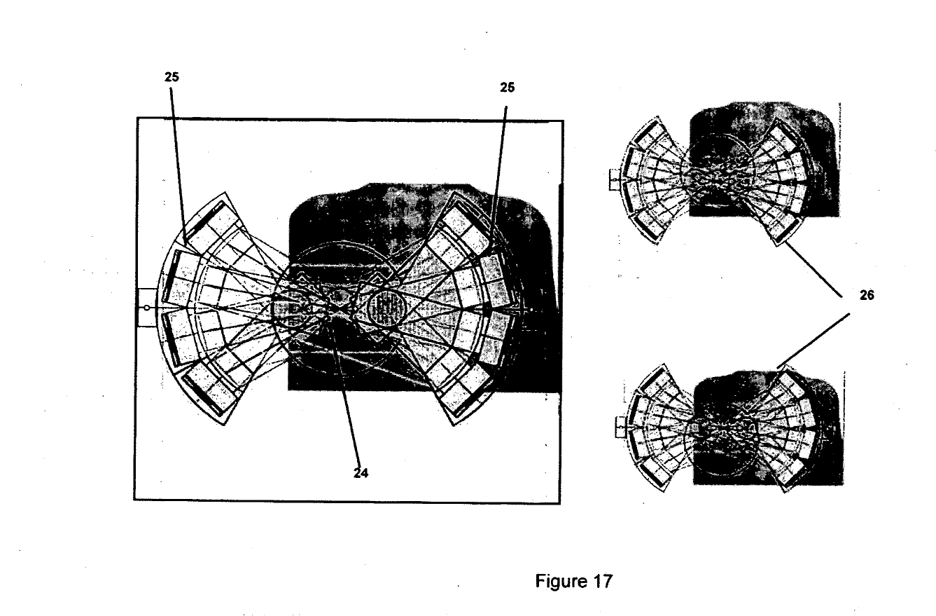

In FIG. 17, the coincidence lines of response 24 are shown between respective breast curved single photon and coincidence gamma detectors 25. Also the entire breast volume can be imaged with translation, rotation, oscillating curved gamma detector motion 26.

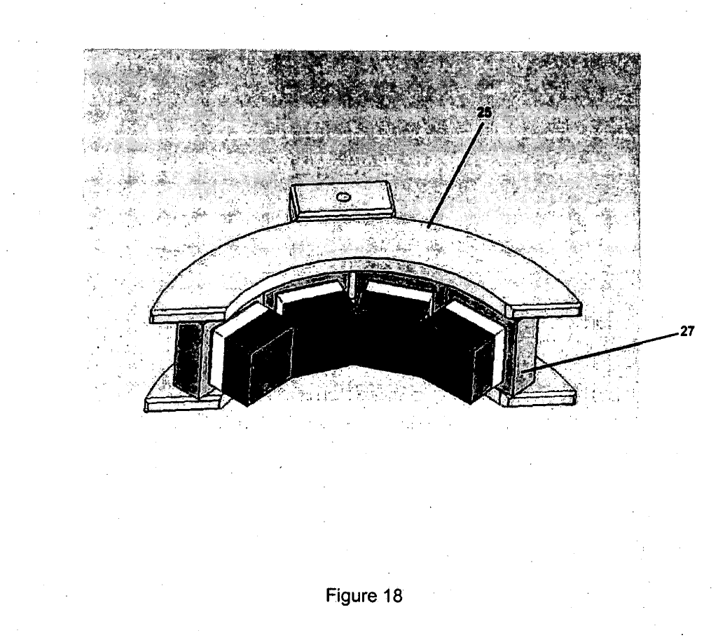

As shown in FIG. 18, the breast curved single photon and coincidence gamma detector 25 may be comprised of breast curved single photon and coincidence gamma detector module(s) 27. The modules 27 are mounted to form an anatomic breast shaped curved detector. The breast curved single photon and coincidence gamma detector module 27 can efficiently image lower energy single photon emitting isotopes, such as Tc-99m, at 140.5 KeV as well as 511 KeV coincidence gamma rays from positron emitters, such as F-18. When imaging positron emitters, two breast curved single photon and coincidence gamma detectors 25 may be operated in coincidence mode facing each other, as shown in FIG. 17.

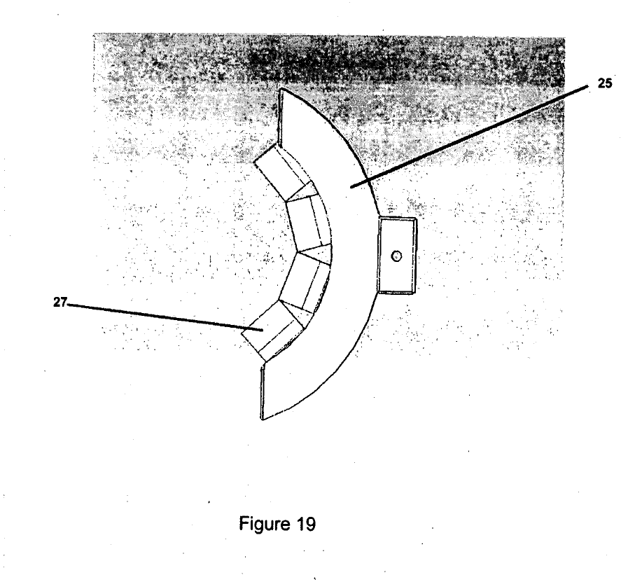

Referring now to FIG. 19, an exemplary breast curved single photon and coincidence gamma detector 25 is shown and includes a plurality of multiple breast curved single photon and coincidence gamma detector modules 27.

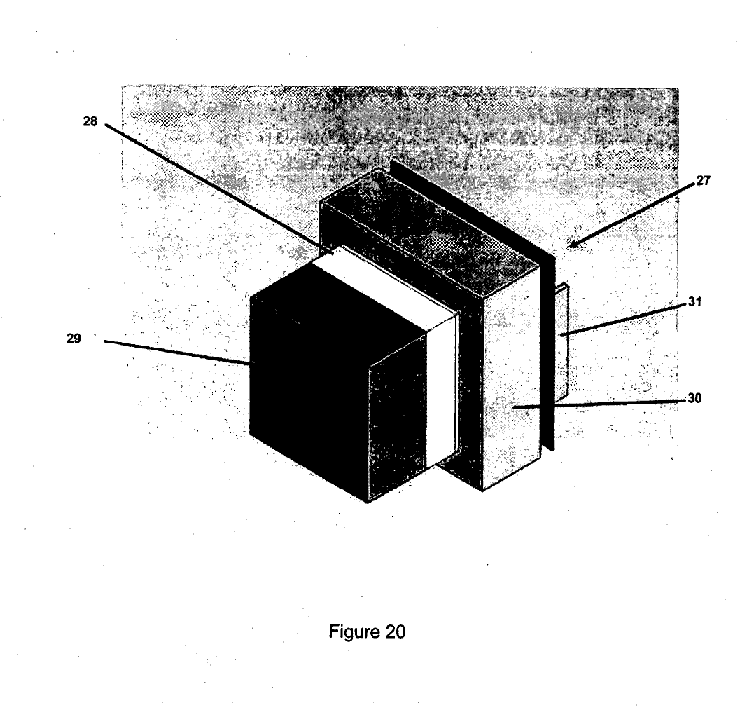

In FIG. 20, the major components of an exemplary breast curved single photon and coincidence gamma detector module 27 are shown. Gamma rays and X-rays enter a module 27 via gamma and coincidence collimator 29. The collimator mechanically focuses gamma rays for a common set of angles. In an exemplary preferred embodiment, parallel hole collimation may be used to allow imaging of single photon emitting radioisotopes. The collimation provides the spatial resolution for SPECT imaging. In 511 KeV positron gamma ray imaging, the collimation acts as an anti-scatter grid to reduce down-scatter radiation from 511 KeV interaction in patient. The collimation may be designed with high resolution parameters and along with positioning of the detector closer to patient provides greatly improved spatial resolution and isotope sensitivity. Pixelated gamma detector elements 28 or pixilated scintillation crystals are used to provide high resolution images. The pixelated array in this exemplary embodiment are interposed between the gamma and coincidence collimation 29 and low profile micro channel amplifier 30. The pixelated gamma detector elements 28 convert gamma rays into visible light. The low profile micro channel amplifier 30 converts the light to electrons that are amplified. The single and coincident gamma DAQ electronics 31 convert the amplified electrons from the low profile micro channel amplifier 30 to digital signals representing geometric position, energy level, and time of gamma event interaction with breast curved single photon and coincidence detector module.

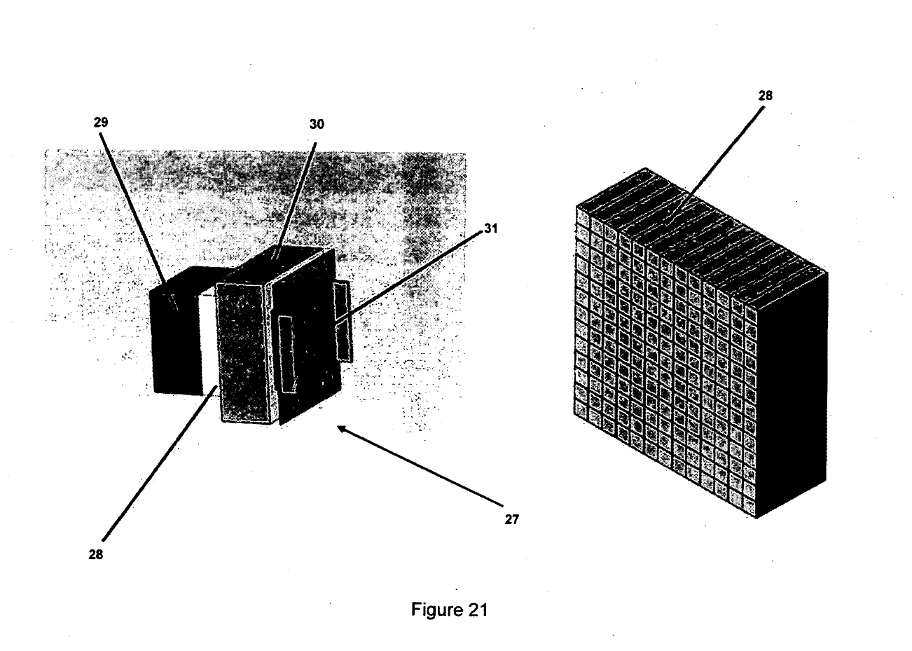

As shown in FIG. 21, an exemplary pixelated gamma detector elements 28 are illustrated and a side view of the breast curved single photon and coincidence gamma detector module 27 are shown. The pixelated gamma detector elements 28 channel the scintillation light down independent channels and allow for high count rate data acquisition with multiple events occurring within the pixelated array. The septa between the respective pixels may be designed to allow shaping of light distributions for high spatial and energy resolution of events in pixels with adaptive weighted positioning algorithms in the single and coincident gamma DAQ electronics 31.

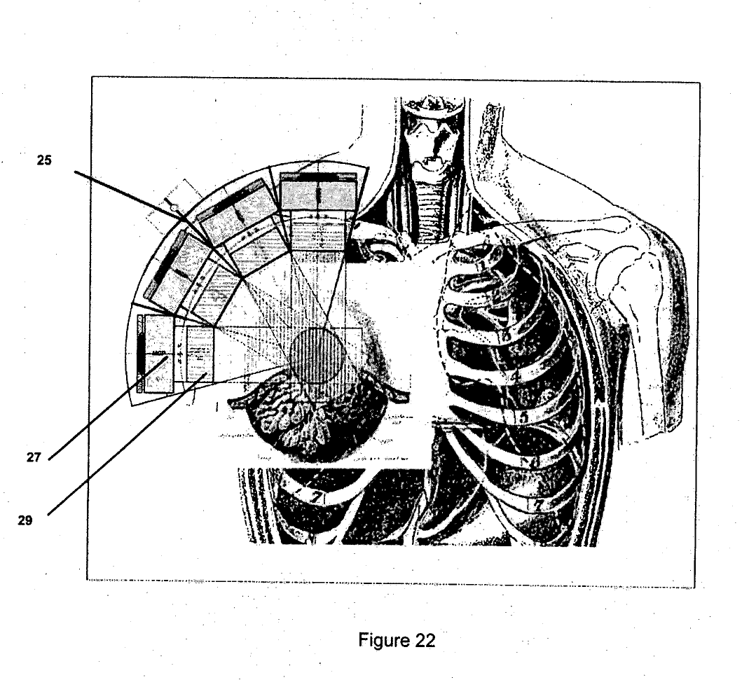

Referring now to FIG. 22, an exemplary breast curved single photon and coincidence gamma detector 25 is shown positioned close to the central breast anatomy allowing for generation of tomographic views of the breast. The breast single photon and coincidence gamma detector modules 27 may be placed in a curved configuration to allow close view of the breast without touching the breast. The breast curved single photon and coincidence gamma detector 25 may be geometrically maneuvered by positioners and motion control systems. Also shown is a focused collimation system 29 to view radioisotope distributions.

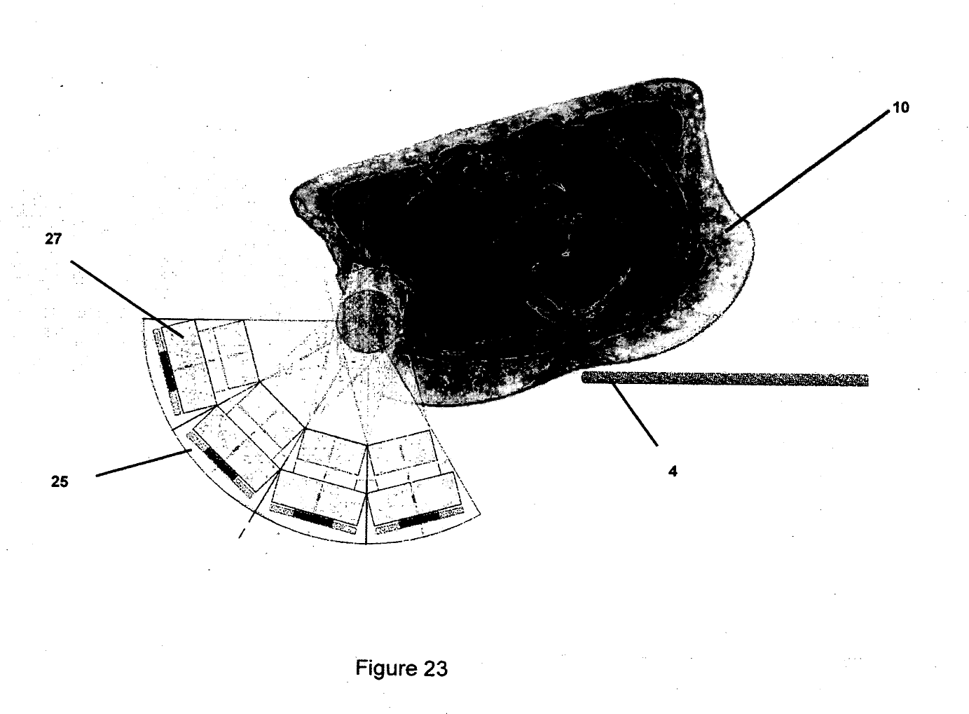

In FIG. 23, the breast curved single photon and coincidence gamma detector 25 is shown generating views of the upper outer quadrant of the patient's breast. Each of the breast single photon and coincidence detector modules 27 provides a tomographic view with unique rotation and oscillation about the outer side of the patient's breast, chest and back while the patient 10 is lying prone on patient table 4 with breast extended via gravity. As mentioned above, this represents an exemplary embodiment, and other physical absolute and relative orientations of the patient, her breast, and the imaging system are possible, such as by imaging the breast with the patient in an upright, seated or standing position, or while the patient lies on her back with the imaging detectors substantially above the patient.

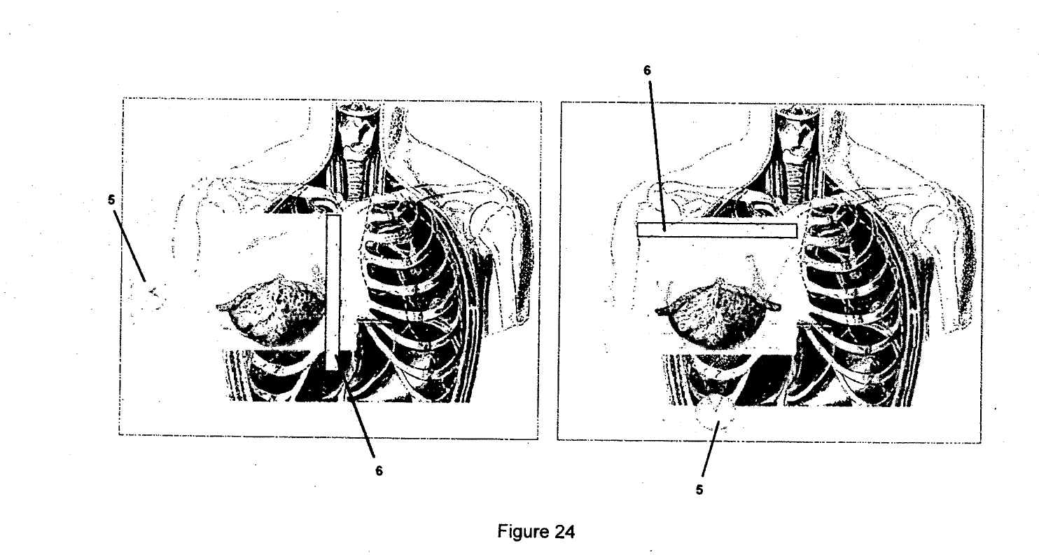

Referring now to FIG. 24, x-ray source 5 and x-ray detector 6 are shown generating a fan/cone beam through a patient's breast. Different views are shown to illustrate the exemplary positions of the x-ray source and detector around the patient's breast. The plurality of views allow reconstruction of x-ray views to form three dimensional tomographic slices of the breast's x-ray densities.

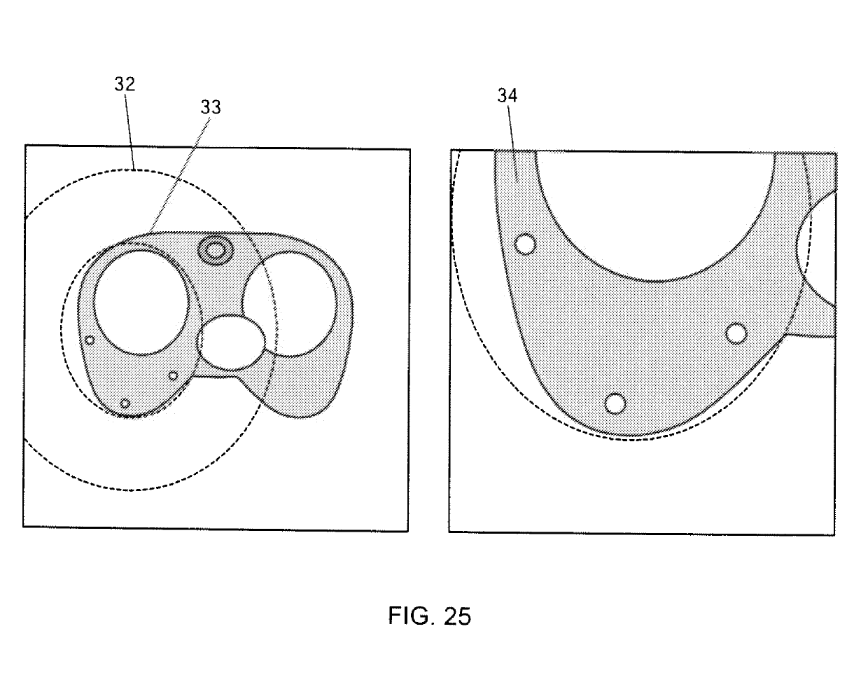

In FIG. 25, exemplary reconstructed tomographic images are shown from the use of programmable detector orbits 32, oscillating curved gamma detector orbits 33 and reconstructed SPECT and PET images 34 from oscillating orbits. The programmable orbits are adjustable to a patient's size and respective anatomy to obtain optimized spatial resolution and high sensitivity images of radioisotope distributions. Unique reconstruction tomographic processing may be utilized to produce high quality imaging with these unique views in space.

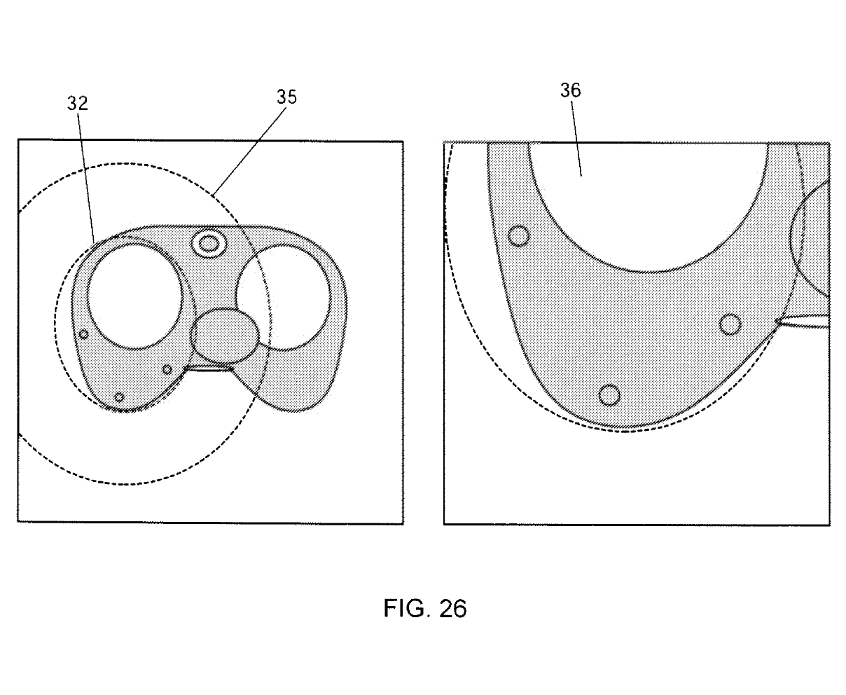

In FIG. 26, exemplary reconstructed tomographic images are shown from the programmable detector orbits 32 and x-ray source and detector orbits 35 and reconstructed x-ray CT image from oscillating orbits 36. Here again, unique reconstruction tomographic processing may be utilized to produce high quality imaging with these unique x-ray views in space.

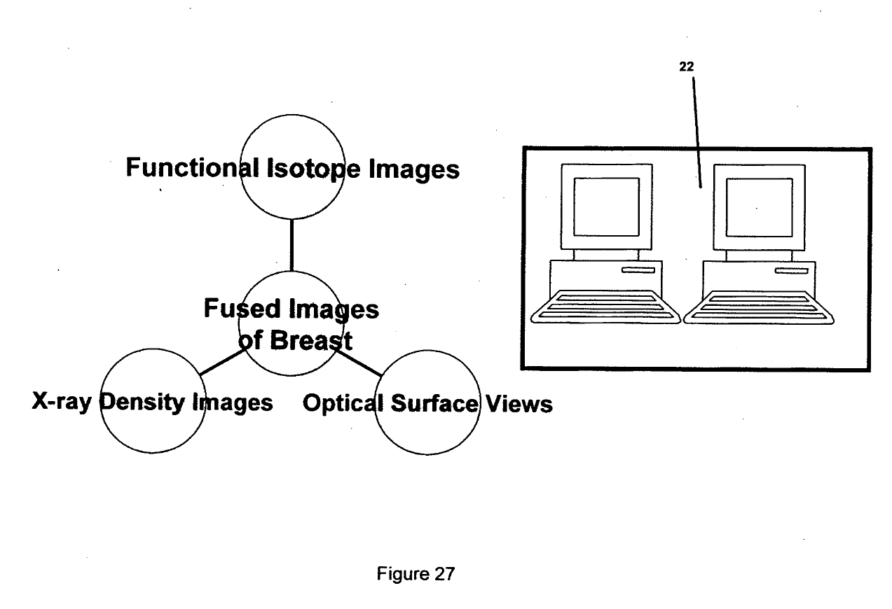

Referring now to FIG. 27, an exemplary breast system display and analysis workstation 22 combines or fuses images obtained from at least a first and a second imaging modality. The radioisotope tomographic images from single gamma photon emitters with micro SPECT, positron emitters with coincident gamma rays for micro PET, combines with x-ray density images from x-ray micro CT and optical surface views for optical surface spectrums to form fused images of the breast.

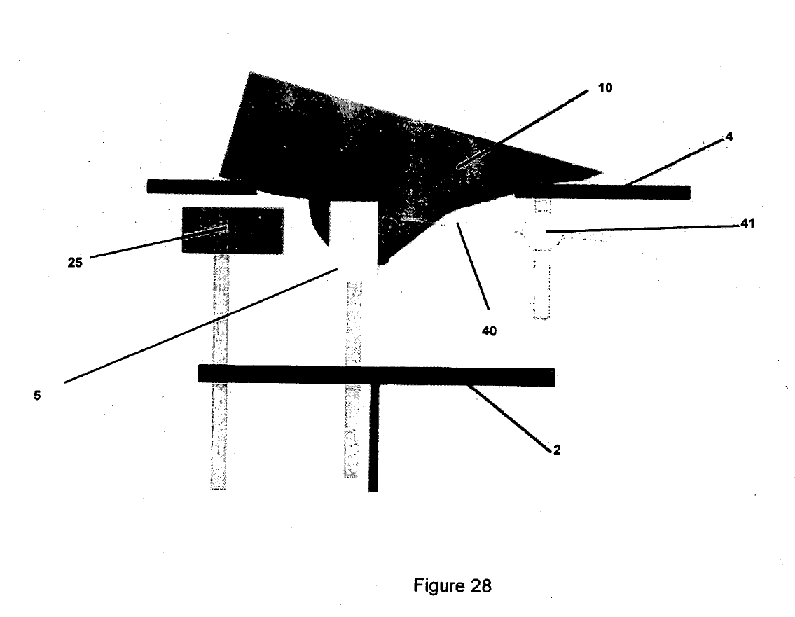

In FIG. 28, an exemplary illustrative biopsy or surgical instrument 40 is shown being guided into the patient 10 and mechanically positioned with the stereo-tactic image guided holder 41. The breast system display and analysis workstation 22 generates interactive image guide information to align the stereo-tactic image guided holder 41 while patient 10 is lying prone and slightly tilted on breast imaging patient table 4. The patient and imaging apparatus may also be in other relative orientations as discussed above. Also shown are the other basic multimodality imaging components of x-ray source 5, breast curved single photon and coincidence gamma detector 25, and rotate table 2 to generate images for biopsy, surgical removal, or therapy of breast cancer. The breast diagnostic apparatus for fused SPECT, PET, X-ray CT and Optical Surface Imaging of the breast described herein is a unique multimodality imaging device to uniquely scan the patient's entire breast, or substantially the entire breast, for the presence of cancer or other medical conditions.

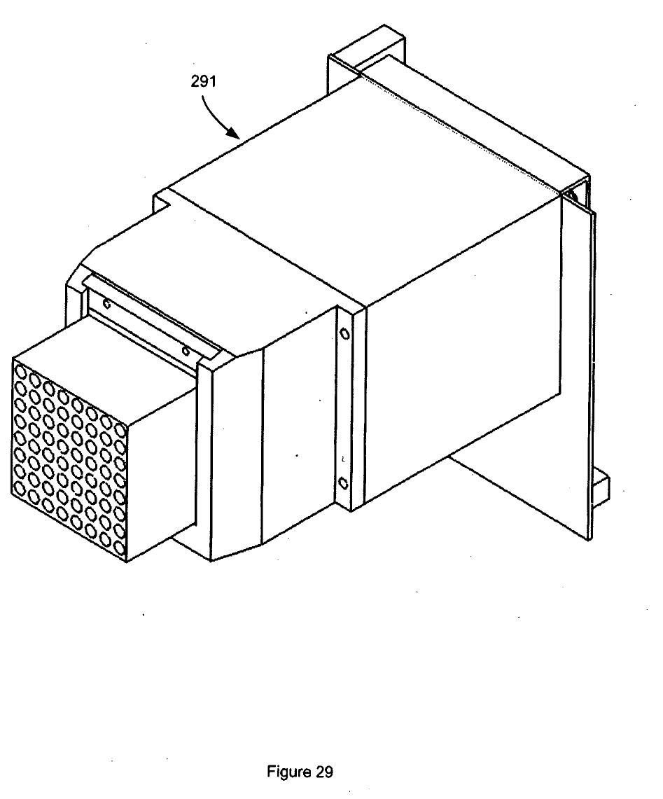

FIG. 29 illustrates a dual modality detection module 291 in one exemplary configuration. The dual modality detection module 291 is designed to detect gamma rays (energetic photons) from single photon nuclear isotopes and coincidence photons from positron emitting isotopes. The module is constructed to allow configurations of curved detector arrays for anatomic specific imaging. The module contains components to detect the position, energy, time of the gamma ray detected by module for both single photon emission tomography (SPECT) and positron emission tomography (PET). Also a set of modules may be configured to perform coincidence detection for positron emission tomography (PET).

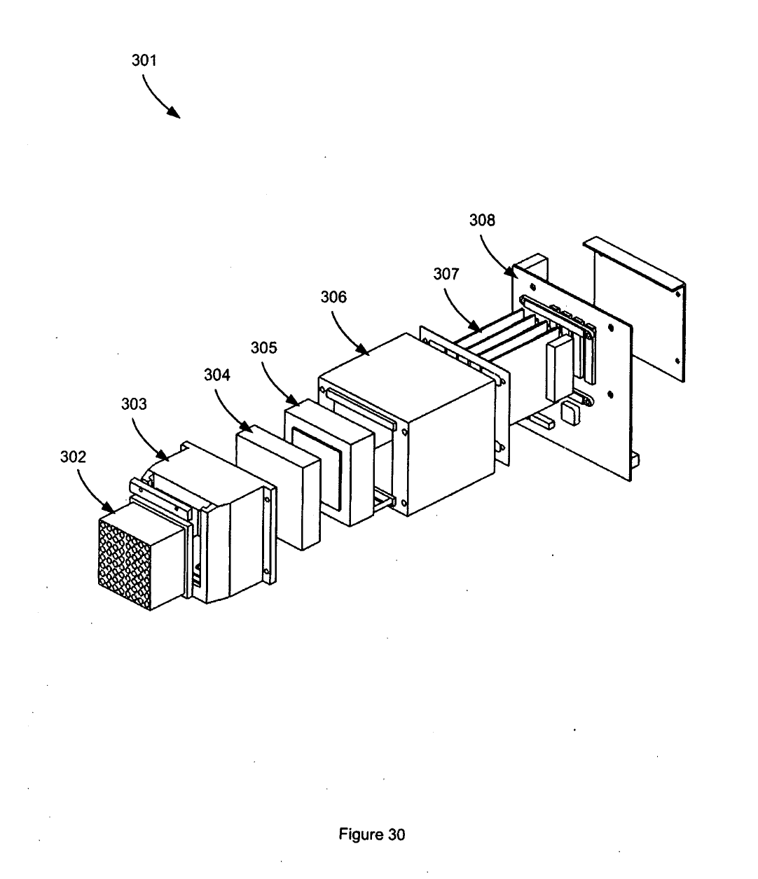

FIG. 30 shows some main components and assemblies of an exemplary dual modality detection module. The present disclosure can be extended beyond two modalities, to three or more modalities fused for the imaging of a medical condition and assisting the diagnosis or treatment of the same. The module 301 is composed of a collimator 302, crystal housing radiation shield 303, pixilated scintillation crystal and optical coupling 304, micro channel plate amplifier 305, amplifier radiation shield housing 306, event processing channel cards 307, and event processor backplane 308.

The collimator 302 allows for collimation of gamma rays for single photon emission computed tomography. Also, the collimator 302 may be used as an anti-scatter and out of field of view radiation shield for positron emission tomography. The collimator along with the crystal housing radiation shield 303 and amplifier radiation shield housing 306 reduce the out of field events and allows focused collection of gamma rays within the desired field of view. This aspect of the detector's construction and operation may be useful for imaging specific sections of anatomy like the breast and brain. Other anatomical portions of a body, e.g., the extremities, may also be imaged using the present detector and system. The pixilated scintillation crystal and optical coupling 304 absorbs and blocks the gamma rays and produces low levels of light photons proportional to the gamma rays' energy.

The light may be collimated or piped through crystal and optical coupling to the micro channel plate amplifier 305. The micro channel plate amplifier 305 or equivalent position sensitive low level light amplifier collects the light from the pixilated crystal and optical coupling 304 and converts the light into electrons with a photo converter. The respective electrons are then amplified by several orders of magnitude and detected by independent detection channel anodes. These anodes will have currents proportional to the energy, position, and time of the detected gamma ray. The respective two dimensional anode array on the micro channel plate amplifier 305 or equivalent position sensitive low level light amplifier are connected to the event processing channel cards 307.

The event processing channel cards 307 amplify, integrate, and can detect the time of the respective pulse generated by detected gamma ray and perform channel independent analog to digital conversions. Also the event processing channel cards 307 discriminate pulses for energy levels and generate accurate timing signal for coincidence detection. The event processing channel cards 307 are connected to the event processor backplane 308. The event processor backplane 308 may include several digital signal processors and micro processor to perform event digital event position, event energy, event time, and compress event data to be sent to frame processor.

It should be understood that the specific application at hand can determine the specific construction and arrangement of the present components of the above illustrative embodiment. For example, as to the software and/or hardware employed in the present systems, the system designer can provide some or all of certain features within said software and/or hardware and/or firmware. Additionally, the layout of the components can incorporate some or all of the above functions and features into a single component or spread them among several discrete components. The circuits described herein may be integrated onto one or more separate circuit boards, wafers, printed circuits, chips, application-specific integrated circuits (“ASICs”) and the like.

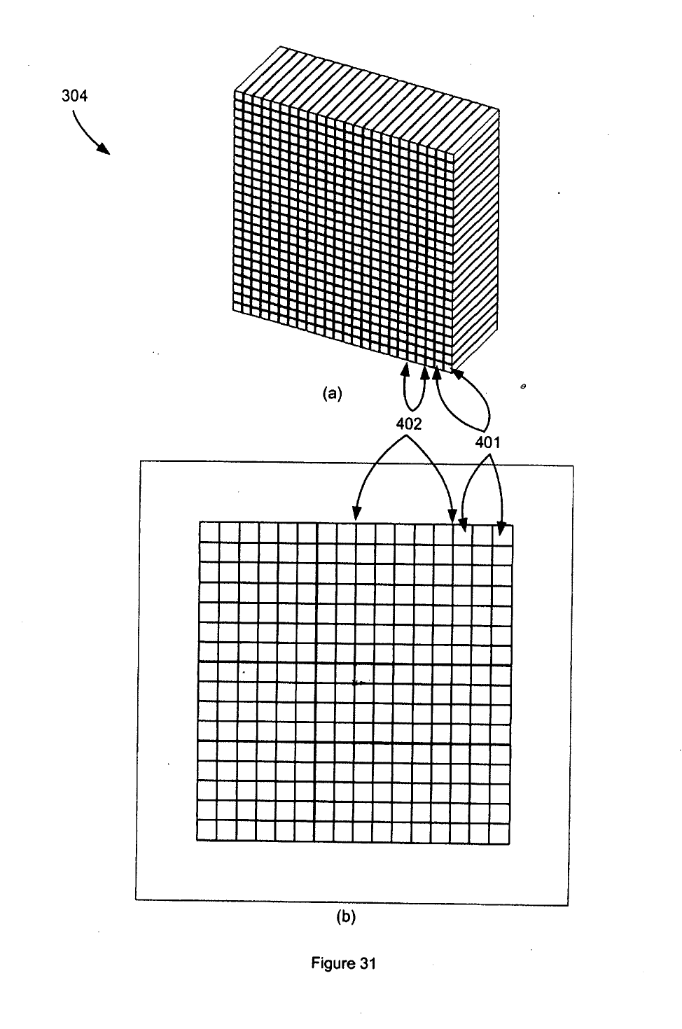

Referring to FIG. 31, the pixilated scintillation crystal and optical coupling 304 are shown with FIG. 31(a) showing a perspective and FIG. 31(b) showing a plan view of the same. The array includes a plurality of scintillation crystals which may be pixelated or divided into a grid of discrete elements. The individual scintillation pixels 401 may be configured into a two dimensional (“2D”) matrix format or array, for example along Cartesian (or x-y) coordinate dimensions. The scintillation pixels 401 are separated with septa material 402. The septa material 402 reflects and assist in collimating the light to the exit end of the scintillation pixels 401. At the end of scintillation pixels 401 an optical coupling may be provided to transfer the light to the juxtaposed micro channel plate amplifier 305 or equivalent position sensitive low level light amplifier.

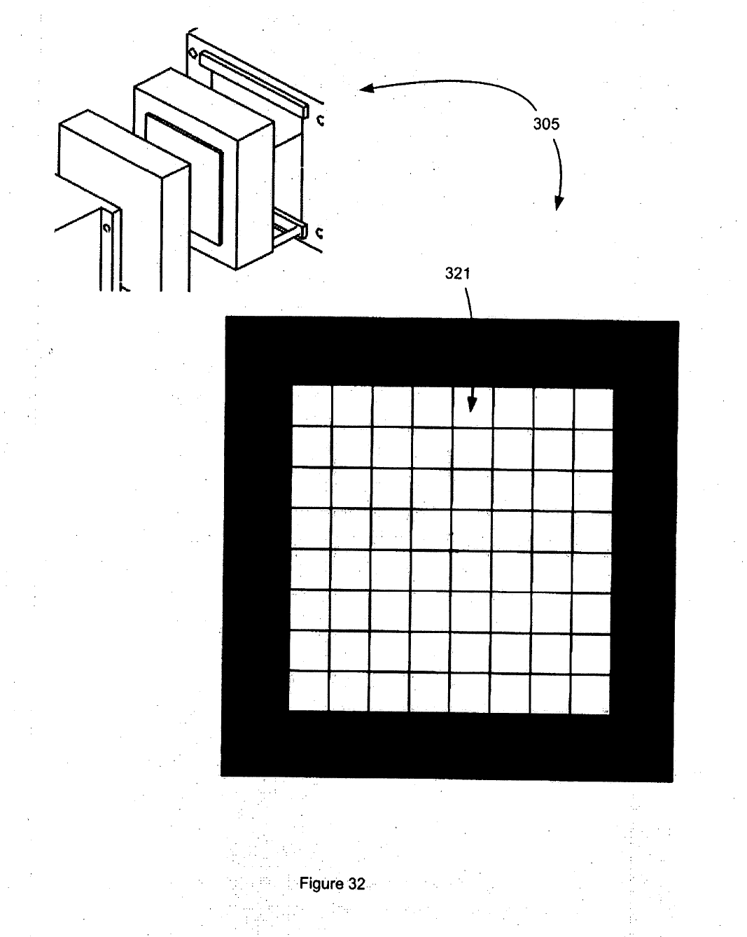

FIG. 32 shows a micro channel plate amplifier 305 or equivalent position sensitive low level light amplifier with independent channel anodes 321. The micro channel plate amplifier 305 or equivalent position sensitive low level light amplifier collects the light from the pixilated crystal and optical coupling 304 (see FIG. 30 and converts the light into electrons with a photo converter. The respective electrons are then amplified by several orders of magnitude and detected by independent channel anodes 321. These anodes will have currents proportional to the energy, position, and time of the detected gamma ray. The respective two dimensional independent channel anode 321 array on the micro channel plate amplifier 305 or equivalent position sensitive low level light amplifier are connected to the event processing channel cards 307 (see FIG. 30 as mentioned previously.

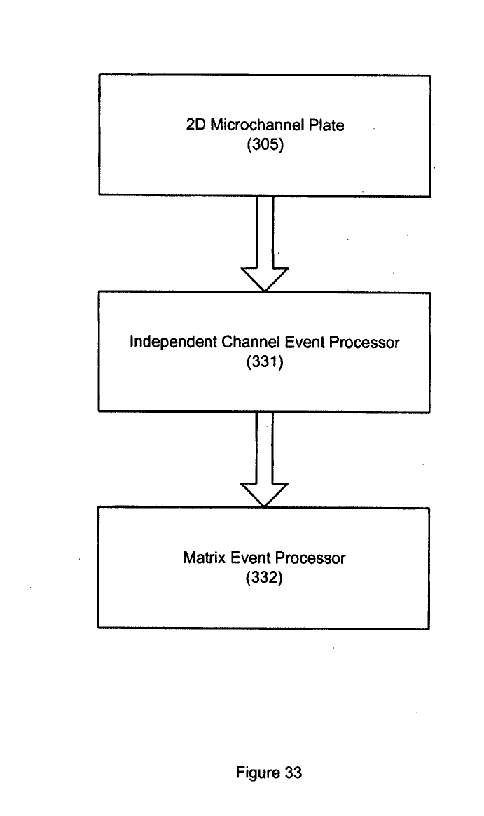

FIG. 33 shows some exemplary processing stages in an event processing channel card 307. The event processing channel cards 307 have independent channel event processor 331 (see FIG. 33). The independent channel event processors 331 are coupled to a matrix event processor 332 (see FIG. 33).

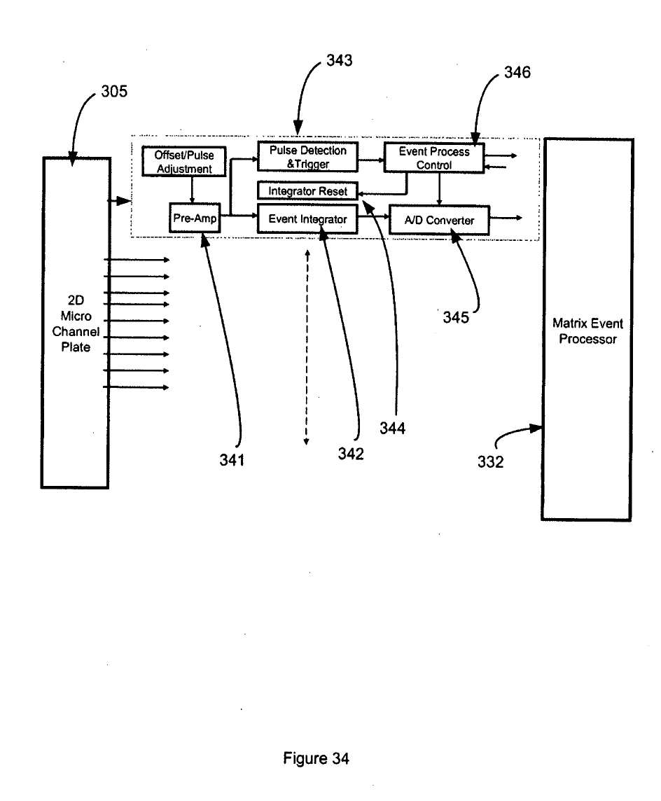

FIG. 34 shows some main processing elements for an exemplary embodiment of an independent channel event processor 331. The independent channel event processors 331 are connected to the two dimensional independent channel anode 321 array on the micro channel plate amplifier 305 (see FIG. 30 or equivalent position sensitive low level light amplifier. The independent channel event processors 331 consist of both analog and digital processing elements. A channel preamplifier (“preamp”) 341 may be coupled to the independent channel anode 321. The channel preamp 341 amplifies the pulse signal and conditions it for event integrator 342 and pulse detection and trigger 343. An digital offset/pulse adjustment is connected to the channel preamp 341 and event integrator 342 to provide canceling out of offsets to zero for event integrator 342. The event integrator 342 has an integrator reset 344 to allow for independent asynchronous pulse integrate reset cycles. The event integrator 342 is connected to the A/D converter 345 to perform analog to digital conversion of integrated pulse amplitude. The event process control 346 controls the pulse detection and respective integrate, hold, reset cycle for digitizing of gamma ray pulse. The pulse detection and trigger 343 detects a pulse greater than a threshold and performs accurate timing detection of the pulse with respective differentiation or constant fraction discrimination components.

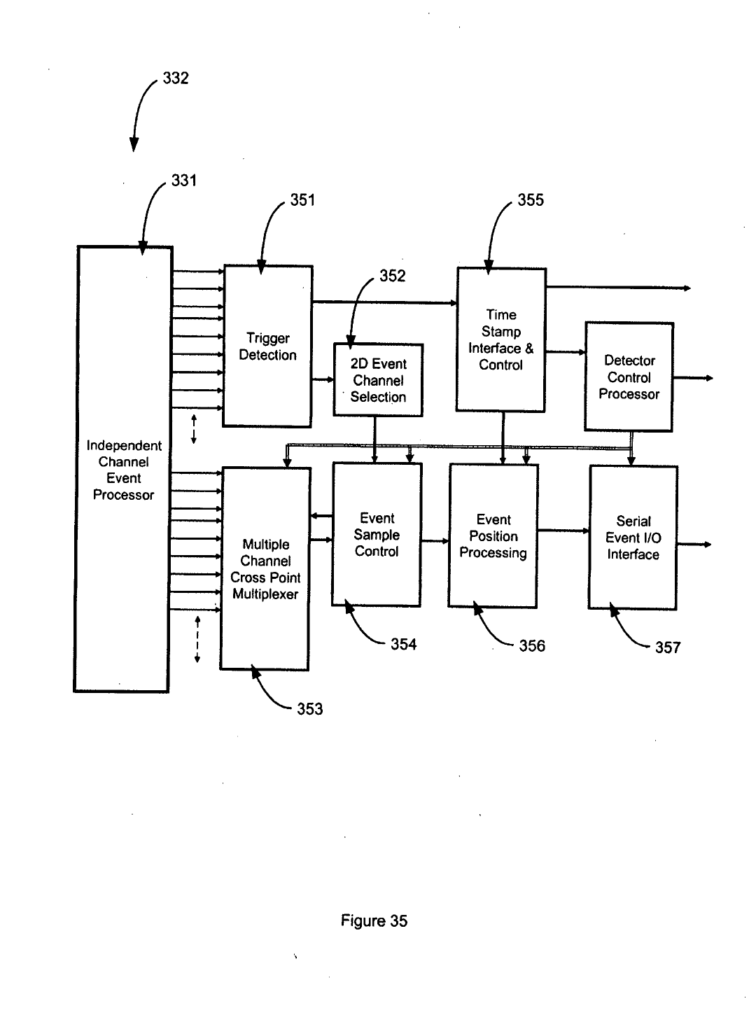

FIG. 35 illustrates an exemplary matrix event processor 332 (see also FIG. 33). The matrix event processor 332 is located event processor backplane 308 (see FIG. 30 and is coupled to a multiple independent channel event processors 331. The matrix event processor 332 allows event data acquisition and the resulting image formation. The event processor 332 includes one or more digital process elements and/or micro processors.

The processing performed by the event processor 332 includes processing performed by the trigger detection processor 351. The trigger detection processor 351 is coupled to a respective event process controller 346 on a plurality of input channels. The trigger detection processor 351 detects an event based upon a time variable or signal, and controls which set of the plurality of channels is to perform the corresponding event processing, signal integration, and analog-to-digital conversion. A 2D event channel selection element 352 determines which set of channels to sample for the event.

An event “centroid” may be defined for an event since the event may trigger multiple channels and have energy distributed over multiple channels. Therefore, a central or typical or representative channel of a plurality of channels can be associated with an event as being most representative of that event. The event sample control 354 takes the centroid channels selected from the 2D event channel selection 352 and generates a synchronization timing sequence to run respective integration and analog-to-digital conversion cycles on selected centroid channels for the event. The timing and control signals from the 2D event channel selection 352 are sent the multiple independent channel event processors 331 via a multiple channel cross point multiplexer 353. The multiple channel cross point multiplexer 353 bi-directionally transfers respective control signals and data collection information to the plurality of channels on the independent channel event processor 331.

When an event is detected by the trigger detection 351, signals are sent to the time stamp interface 355 which is coupled through an interface to a common time stamp control process for generation and return of a time-of-event output for the event relative to other possible events in the system. The time stamp interface 355 interacts with an external time stamp processor and is used for coincidence detection of events. The time stamp interface 355 allows the event sample control sequence of sampling to be aborted if the event is not in coincidence with another event trigger on a 180 degree spatially-opposed event channel.

The event position processor 356 uses information from each channel of the centroid of an event to determine the position of a source of a gamma ray detected by a respective pixel in pixilated scintillation crystal and optical coupling 304 (see FIG. 31). The position is computed as a weighted center of gravity calculation for a closest pixel position determination. The event position, energy, and time are determined by the event position processor 356 and sent to the serial event input/output (“I/O”) interface 357.

The serial event I/O interface 357 is coupled to a framing processor for respective image formation and eventually generating a modality, e.g., SPECT or PET image output.

The detector control process allows for calibration and general control of the multi- (e.g., dual-) modality detection module 301 (see FIG. 30.

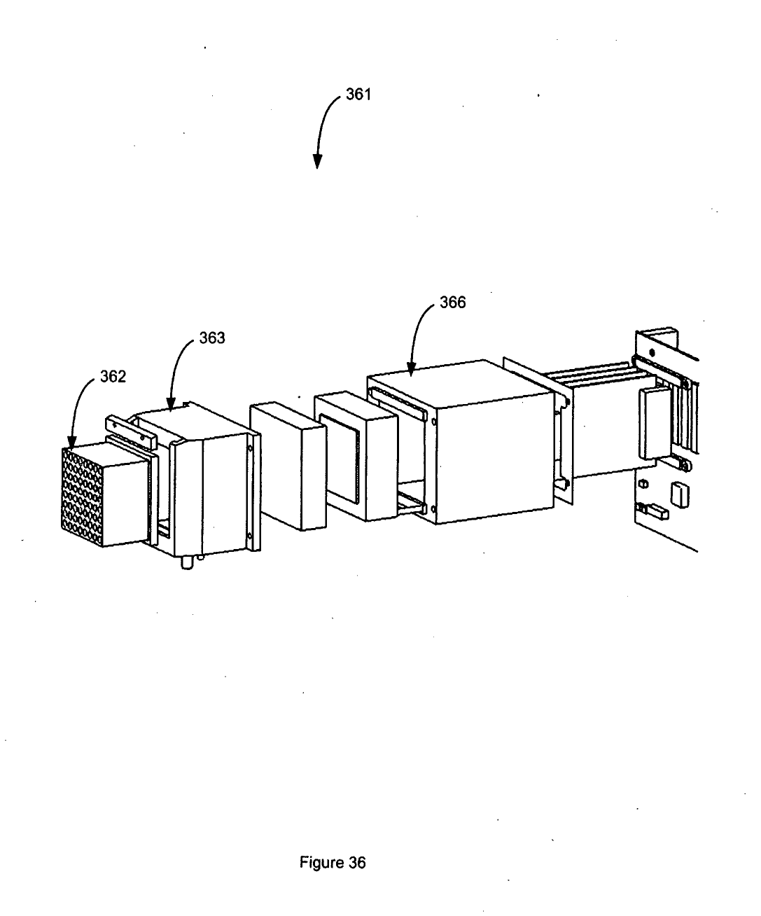

FIG. 36 illustrates another exemplary view of some main components of a dual modality detection module 361. The collimator 362, crystal housing radiation shield 363, and amplifier radiation shield housing 366 can reduce out of field of view radiation which could cause imaging errors. These respective shields also provide control temperature environment for the dual modality detection module 361.

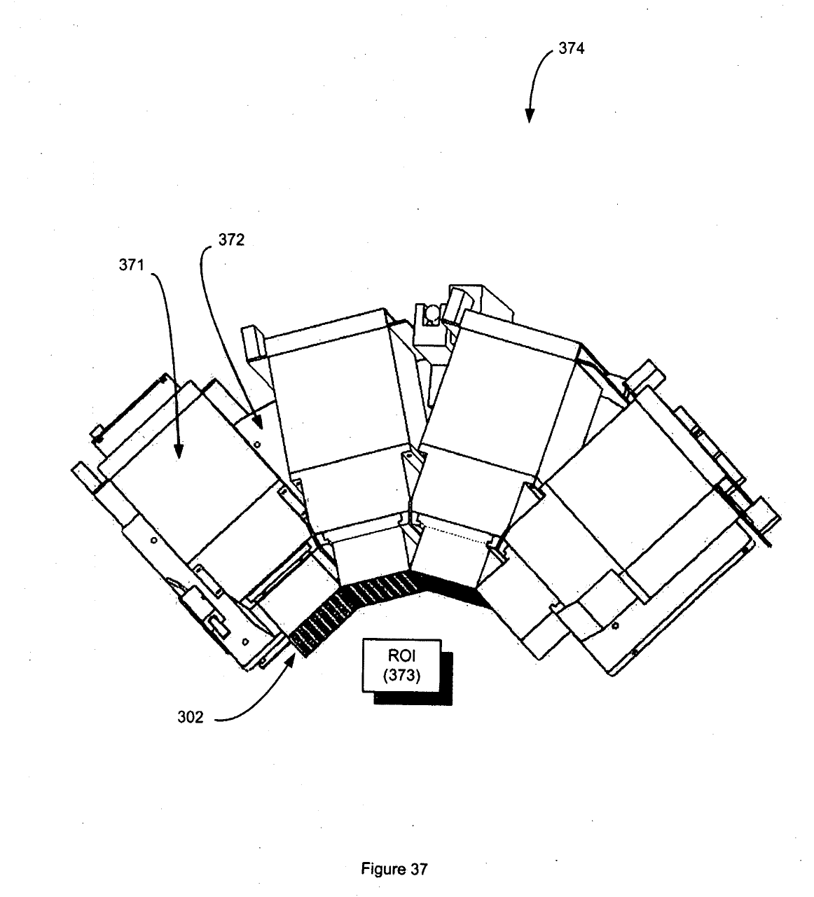

FIG. 37 illustrates an exemplary system having the multi- (e.g., dual-) modality detection modules 371 described above, having juxtaposed positions relative to one other so as to form an approximately curved dual modality detector array 374 with a substantially circular general profile (approximating a circle) about a certain region of interest (“ROI”) 373. In some embodiments, the ROI includes or consists of a space for imaging a patient's organ or a diseased body part (e.g., brain, breast, arm, leg, etc.). It can be appreciated that, with collimators 302 in place, the individual detection modules 371 take on overlapping lines of sight covering the ROI 373. The dual modality detection modules 371 are connect via a base plate 372 and can be translated and oscillated as a unit. The base plate provides structural support to fix the detection modules 371 thereto to provide a common spatial frame of reference. In some embodiments, the individual detection modules 371 are rigidly fixed to the support base plate 371 and therefore the individual detection modules 371 are spatially fixed relative to one another. The base support plate 371 can be rotated as a whole and the detection modules 371 attached to the support plate 372 will rotate along with it and therefore be moveable with respect to a patient, organ, ROI, patient support platform, organ support structure, or the like. This allows imaging with the multiple modes of imaging employed from a variety of directions as needed. Note that other degrees of freedom, such as swiveling, tilting, vibrating, spinning, spiral movement, and the like are available in addition to the rotation described above to allow a better or substantially full spatial coverage of the ROI 373 in use for generating the tomographic images. An articulated element can be used to couple said structural support frame of the imaging apparatus to the detector elements so that they can move along said degrees of freedom. Joints, hinges, motors, lead screws, ball-bearings and other mechanical and electromechanical elements can be used to articulate said movement.

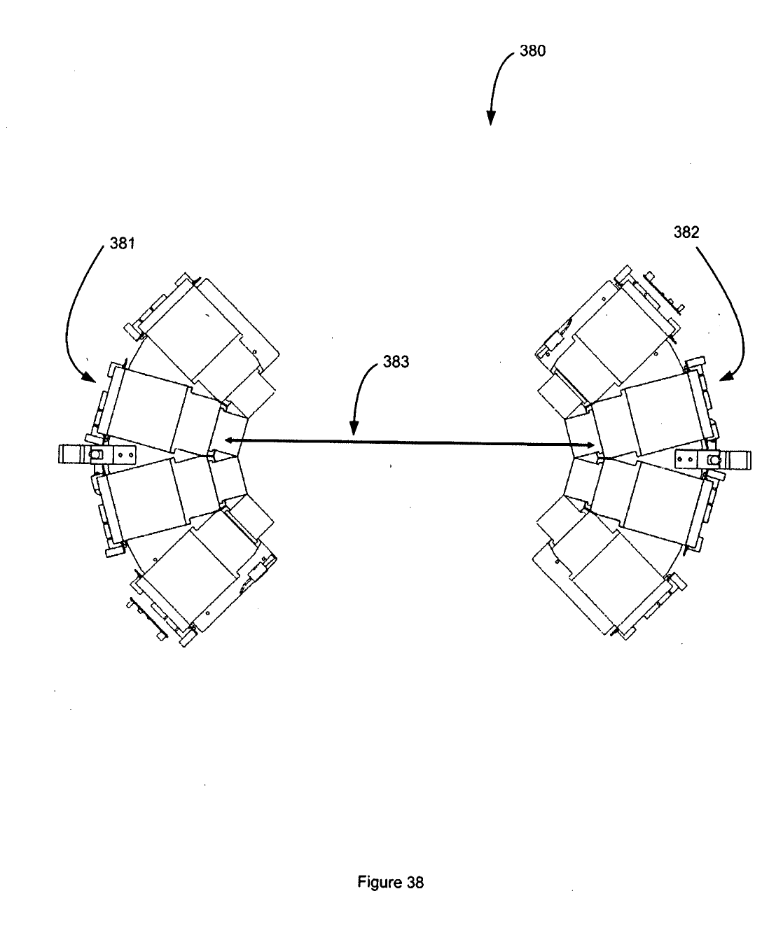

FIG. 38 illustrates a pair of exemplary curved dual modality detector arrays 380 positioned 180 degrees with respect to one another to form a positron emission tomography imaging apparatus according to an exemplary embodiment. Energy from 511 KeV gamma rays from a positron annihilation event, traveling along line 383 in opposing directions, can be detected by the pair of opposing detectors 381 and 382. The curved detector arrays 380 can themselves be rotated about a central axial axis, translated radially, tilted outside a plane of their curvature (outside a plane normal to the central axial axis), or oscillated about any given axis to achieve a more complete image coverage according to principles of superposition and tomographic imaging. Additionally, the individual detector modules may be rotated, translated, tilted, and oscillated about one or more axes in one or more degrees of freedom. Motorized apparatus and actuators can be used to accomplish the motions described above.

Embodiments of the present systems and methods include a multi-modality tomographic modular imaging detector comprising at least one 2D pixelated scintillation crystal array, a geometric optical coupling, a compact micro channel amplifier plate with a 2D matrix of independent anode channels, an independent channel event processing for each of the anodes, a 2D matrix event processor for gamma rays spatial, energy, and time of detection.

The multi-modality tomographic specific modular imaging detector may further include means for determining a super-resolution with a plurality of pixels per anode channel, or with adaptive weighted position detection.

The multi-modality tomographic specific modular imaging detector can further include means for coincidence imaging with two more modules to perform positron emission tomographic imaging.

The multi-modality tomographic specific modular imaging detector modules may be further cascaded into a mosaic of substantially curved detector arrays for single photon emission computed tomographic imaging.

The multi-modality tomographic specific modular imaging detector may be further cascaded into a mosaic for dual curved detector arrays to perform positron emission tomography.

The multi-modality tomographic specific modular imaging detector may be further coupled to a respective mechanical collimators for single photon emission tomography.

The multi-modality tomographic specific modular imaging detector may be further coupled to mechanical anti-scatter baffle collimators for positron emission tomography.

The multi-modality tomographic specific modular imaging detector may be further coupled to coincidence detection and 2D image histogram processing modules for image generation.

The multi-modality tomographic specific modular imaging detector may include a plurality of translatable and rotatable detector units to perform super resolution single photon emission tomography.

The multi-modality tomographic specific modular imaging detector can be designed to be translatable and rotatable to perform super resolution positron emission tomography.

Accordingly, at least two imaging modalities (e.g., X-ray and PET; X-ray and SPECT; CT; and others) can be employed to detect a common condition. The imaging apparatus and method can be employed to fuse together or combine the outputs of said detection modalities into a single useful output.

In some embodiments, the multi-modal detection comprises a first imaging modality (e.g., PET or SPECT) for detecting a functional aspect of a subject or organ while a second imaging modality (e.g., X-ray) is used for detecting an anatomical aspect of a subject or organ.

The apparatus described above allows, in some embodiments, dual- or multi-modality imaging of a patient without requiring the patient to move from a first position to a second position corresponding to the two imaging modalities used. As opposed to some systems presently in use that require moving the patient or translating the gurney on which the patient is placed from a first modality imager to a second modality imager, here, the patient can be imaged using more than one modality coupled to a common framework while the patient remains substantially stationary. This can improve the clarity, resolution, and accuracy of the multi-modal image, and provide greater comfort and safety to the patient.

In other embodiments hereof, imaging an organ can be conducted without requiring physical or mechanical contact between the organ and the imaging apparatus. For example, unlike present imaging systems that often require a woman's breast to be contacted or deformed or pressed by an uncomfortable imaging device, the present system allows a no-contact imaging of the breast, especially if presented within a region of interest within the present curved array detector system.

As discussed above, these components and processors can be implemented in software, hardware, firmware, or various combinations thereof, and the present illustrative demarcation of the functions and block diagrams and components described can be accomplished flexibly in more than one way. For example, one or more additional components may be incorporated into the present system, or a single component can be constructed to perform the functions of two or more components described in the present preferred embodiments.

The present disclosure is not intended to be limited by its preferred embodiments, and other embodiments are also comprehended and within its scope. Numerous other embodiments, modifications and extensions to the present disclosure are intended to be covered by the scope of the present inventions as claimed below. This includes implementation details and features that would be apparent to those skilled in the art in the mechanical, logical or electronic implementation of the systems described herein.

What is claimed is:

1. A medical imaging apparatus, comprising:
a first detector contributing a first imaging modality for detecting a medical condition in a region of interest;
a second detector contributing a second imaging modality for detecting said medical condition in said region of interest, said second imaging modality being different than said first imaging modality; and
a structural frame supporting both of said first and second detectors, said frame providing a common mounting point for supporting said detectors and positioning said detectors in a configuration supporting imaging of said region of interest.

2. The apparatus of claim 1, said first detector comprising a photon detector.

3. The apparatus of claim 1, said structural frame allowing imaging a patient using both of said first and second imaging modalities without requiring an intervening movement of a subject being imaged.

4. The apparatus of claim 1, said structural frame being coupled to said detectors with articulated elements for permitting a movement of said detectors along at least one degree of freedom.

5. The apparatus of claim 1, said first detector comprises an anatomical detector, and said second detector comprises a functional detector.

6. The apparatus of claim 1, said first and second imaging modalities comprising respective outputs combinable to form a fused multi-modal output of said apparatus for detection of said medical condition.

7. The apparatus of claim 1, said first and second detectors including first and second respective collimators disposed at respective input ends of said first and second detectors to collimate a respective input to said first and second detectors.

8. The apparatus of claim 7, said collimators comprising a plurality of longitudinal channels disposed substantially parallel to one another within a shielding matrix, said longitudinal channels permitting passage of a respective input to a corresponding detector and said shielding matrix comprising a material that substantially prevents passage of said respective inputs to said corresponding detector.

9. The apparatus of claim 1, further comprising a mechanical anti-scatter baffle collimator for collimating an input to said detectors.

10. The apparatus of claim 1, further comprising a plurality of independent channels for capturing a respective plurality of signals responsive to a detected event.

11. The apparatus of claim 1, further comprising a coincidence detection apparatus for determining an event.

12. A method for generating a multi-modal image for detecting a medical condition, comprising;
imaging a region of interest using a first detector having first imaging modality for detecting said condition;
imaging said region of interest using a second detector having second imaging modality for detecting said condition;
coupling said respective detectors to a structural support frame so as to support said detectors and position said detectors in a configuration allowing imaging of said region of interest; and
combining respective outputs of said first and second detectors so as to form a multi-modal combined output thereof indicative of said condition.

13. The method of claim 12, where imaging with said first imaging modality comprises detecting a photon.

14. The method of claim 12, where imaging with said second modality comprises detecting a charged particle.

15. The method of claim 12, where imaging with said first and second modalities comprises detecting a photon and a charged particle, respectively.

16. The method of claim 12, further comprising correction of an attribute of said combined output.

17. The method of claim 12, further comprising calibrating said first and second imaging modalities.

18. The method of claim 12, further comprising placing an array of said first imaging modality detectors and said second imaging modality detectors along a substantially curved profile for the purpose of imaging a region of interest containing an organ.

19. The method of claim 12, further comprising placing a selected subset of a patient's body so that a selected organ lies within a region of interest generally defined by said first and second imaging modality detectors.

20. The method of claim 12, further providing said combined output to a program for generating a viewable image including information collected from said first and second imaging modalities and indicative of said condition.

21. The method of claim 12, further comprising placing a female human patient upon a support surface including at least one opening through which at least one breast may be imaged using said first and second imaging modalities.

22. The method of claim 12, further comprising receiving a plurality of independent channel signals corresponding to respective outputs of respective pixelated scintillation crystals of said first and second imaging modalities, and determining a position of an event based thereon.
